(19) United States
(12) Patent Application Publication
(10) Pub. No.: US 2022/0356088 A1
(43) Pub. Date: Nov. 10, 2022

(54) SELECTIVE REMOVAL OF CHARGED SPECIES

(71) Applicant: Oxford University Innovation Limited, Oxford (GB)

(72) Inventors: Nicholas Peter HANKINS, Oxford (Oxfordshire) (GB); Steve COLLEY, Oxford (Oxfordshire) (GB); Licheng SHEN, Oxford (Oxfordshire) (GB)

(21) Appl. No.: 17/642,968

(22) PCT Filed: Sep. 16, 2020
(86) PCT No.: PCT/GB2020/052229

§ 371 Date: Mar. 15, 2022

(30) Foreign Application Priority Data
Sep. 16, 2019 (GB) 1913334.7

(51) Int. Cl. C02F 1/64; C02F 1/56

(52) U.S. Cl. CPC C02F 1/64; C02F 1/56; C02F 2101/203

(57) ABSTRACT

The present invention relates to a process for selectively removing a first charged species from a plurality of charged species in solution, which process comprises: treating a solution with a functionalised polymer and a surfactant, wherein the solution comprises a plurality of charged species dissolved in a solvent, wherein the plurality of charged species comprises the first charged species and at least one further charged species which is different from the first charged species, and wherein the functionalised polymer comprises groups that bind preferentially to the first charged species.

### FIELD OF THE INVENTION

The invention relates to a process for selectively removing a particular charged species, for instance a metal ion, from a mixture of different charged species in solution.

### BACKGROUND TO THE INVENTION

There are currently a number of well known methods for the removal of charged species, such as metal ions, from liquid-phase effluents. Examples of effluent that typically contain charged species that require removal—or whose removal would be beneficial both economically, environmentally and (by extension) socially—are effluents in the metal finishing industry, the mining and mineral processing industries, the textile and battery industries, the catalyst manufacturing industry, and effluents arising from soil washing of heavy metal contaminated land. Metal ions are widely used in industrial processes and some of them will present in the associated effluent streams. There are two main incentives for removing the metal ions in aqueous solutions: economic and environmental. Regarding the environmental incentives, the discharge regulations on metal ions are becoming more stringent, because the latter are not bio-degradable and can bioaccumulate in the human body as well as in the bodies of other animals, leading to deleterious effects of health. Regarding the economic incentives, platinum group metals (PGMs), gold and silver have a market value of approximate £20/g. Similarly, copper has a market value of £5/kg. Thus, it is also worth recovering such metals from effluents as dilute as 1 mg/l provided a cost-effective method is available.

All metal ion removal techniques have their inherent advantages and limitations in various applications. Chemical precipitation is widely applied in high concentration streams due to its relatively low capital cost and is a straightforward process. This method, however, is less effective or selective and less economical to treat dilute solutions. Moreover, the cost of handling and treating large amounts of sludge is substantial. Another commonly used method is ion exchange, which is highly effective to remove small amounts of high concentration metal-ion contaminated water. Selectivity is high but the cost and secondary pollution when regenerating resin are critical. Furthermore, the required solid-liquid, fixed-bed operation is complex. Thus ion exchange resins are also not economical to treat large amount of dilute metal-ion wastewater. Electrochemical techniques are regarded as a rapid and well-controlled method to remove metals with fewer chemical additions and less sludge production. The drawbacks are high capital and running costs, limited selectivity and complexity of operation. Adsorption is an alternative method to treat dilute systems, but the processes suffer from similar drawbacks to ion-exchange and the balance between cost and effectiveness of physico-chemical adsorbents is difficult to make. Biosorption has proven a promising sustainable removal method. The advantages are high overflow rate and low production volumes of concentrated sludge. The capital, maintenance and operational cost, however, are high. The sludge produced by the coagulation-flocculation method has good settling and dewatering properties, but the amount of chemical dosage, lack of selectivity and the sludge treatment/disposal are the main disadvantages to overcome. Finally, membrane filtration technology is a selective removal method based on size of species, but high cost, membrane fouling and low permeate flux are the limitations.

Hankins et al., Separation and Purification Technology, 2006, 51(1), page 48-56 mentions the use of polyDADMAC and humic acid to remove metal ions. First the metal ions bind to the humic acid, then, polyDADMAC is added to form flocculates with a relatively large size. The bound metal ions are thus separated from free ions in solution using ultrafiltration or settling. The humic acid acts as a polyelectrolyte within the method disclosed. The process is not reversible, and thus the starting materials cannot be recycled.

Thus, all of the methods mentioned above have their own drawbacks.

WO 2016/079511; Shen, L. C., Nguyen, X. T., & Hankins, N. P. (2015) “Removal of heavy metal ions from dilute aqueous solutions by polymer—surfactant aggregates: A novel effluent treatment process”, Separation and Purification Technology, 152, 101-107; Shen, L. C., Lo, A., Nguyen, X. T., & Hankins, N. P. (2016) “Recovery of heavy metal ions and recycle of removal agent in the polymer—surfactant aggregate process”, Separation and Purification Technology, 159, 169-176; Shen, L. C., Hankins, N. P., & Singh, R. (2016) “Surfactant and Polymer-Based Technologies for Water Treatment”, Emerging Membrane Technology for Sustainable Water Treatment, 249; L. C. Shen, J. Wu, S. Singh, and N. P. Hankins (2017) “Removal of Metallic Anions from Dilute Aqueous Solutions by Polymer—Surfactant Aggregates”, Desalination, 406, 109-118; and L. C. Shen, N. P. Hankins (2017) “Metallic Anion Recovery from Aqueous Streams and Removal Agent Recycle in the Polymer-Surfactant Aggregate Process”, Desalination, 406, 67-73 relate to processes for removing charged species from solution, which involves using a polymer-surfactant aggregate to remove the charged species. Such a process permits the recycling of the materials used as reagents for the charged species removal, thus avoiding sludge production and providing an environmentally friendly and sustainable way to remove charged species.

Room for improvement in the above process remains in the area of selectively removing a particular ion from a mixture of ions in solution. Removing a particular metal ion selectively from a mixture of metal ions in aqueous solution is particularly difficult, especially, for instance, from a mixture with other metal ions of the same number of charges, such as removing Zn²⁺ from Pb²⁺. Resin-based ion exchange technologies have in the past been employed (Colley, S. W., Kauppinen, P., Stevens, J., & Mac Namara, C. (2014) “Structure and properties of highly selective and active Advanced Ion Exchange (AIX) materials. Enabling and expanding sustainable metal recovery”, Chimica Oggi-Chemistry Today, 32, 5). However, ion exchange technologies have their drawbacks. As mentioned above, cost and secondary pollution when regenerating resin mean that ion exchange resins are not economically feasible to treat large amounts of dilute heavy metal wastewater. Furthermore, performance of resin-based ion exchange technology is limited by a relatively slow kinetic and hydraulic performance due to the heterogeneous solid-liquid interactions which are required for its operation, and by the corresponding complexity of fixed-bed process operation. An economical and sustainable technology which could increase the treatment speed and/or selectivity of removal compared to ion exchange resins would be desirable.

### SUMMARY OF THE INVENTION

The inventors have developed a very simple, low cost process using smart, inexpensive, easily manufactured and recyclable materials to selectively recover charged species, such as valuable metals, from industrial process and effluent streams. The process is non-complex and sustainable, typically being based on mixing and settling or filtration, using inexpensive equipment such as tanks, mixers, pumps and pipes. It generally uses substrates available in bulk at low cost, such as polymers and surfactants. Importantly, the polymer employed in the present invention is modified via functionalisation to allow selective removal of the target ion. In the presence of the target charged species for recovery, the removal agent is self-flocculating and can easily be removed prior to facile recovery of the target charged species. The removal agent can also be recycled, reducing both cost and environmental impact due to zero waste discharge. The process of the invention may produce little or no sludge and all materials can be recycled. Indeed, one key advantage of the process of the invention is the ability to recycle the removal reagent, thus conferring a green and sustainable operation.

Accordingly, the invention provides a process for selectively removing a first charged species from a plurality of charged species in solution, which process comprises: treating a solution with a functionalised polymer and a surfactant, wherein the solution comprises a plurality of charged species dissolved in a solvent, wherein the plurality of charged species comprises the first charged species and at least one further charged species which is different from the first charged species, and wherein the functionalised polymer comprises groups that bind preferentially to the first charged species.

In another aspect, the invention provides the use of a functionalised polymer and a surfactant to selectively remove a first charged species from a solution comprising a plurality of charged species dissolved in a solvent, wherein the plurality of charged species comprises the first charged species and at least one further charge species which is different from the first charged species, and the functionalised polymer comprises groups that bind preferentially to the first species.

Further provided is the use of a polymer-surfactant aggregate (PSA) to selectively remove a first charged species from a solution comprising a plurality of charged species dissolved in a solvent, wherein the polymer-surfactant aggregate comprises a functionalised polymer and a surfactant, the plurality of charged species comprises the first charged species and at least one further charge species which is different from the first charged species, and the functionalised polymer comprises groups that bind preferentially to the first species.

The invention also provides a modified polymer-surfactant aggregate (modified PSA), which comprises:

(i) a polymer-surfactant aggregate (PSA), comprising a functionalised polymer and a surfactant; and

(ii) a first charged species,

wherein the functionalised polymer comprises groups that bind preferentially to the first charged species and the first charged species is bound to the groups.

Further provided is a polymer-surfactant aggregate (PSA), comprising: (i) a functionalised polymer which comprises groups that are capable of binding preferentially to a first charged species, and (ii) a surfactant.

Also provided by the present invention is a process for selectively removing a first charged species from a plurality of charged species in solution, wherein the solution comprises a plurality of charged species dissolved in a solvent, wherein the plurality of charged species comprises the first charged species and at least one further charged species which is different from the first charged species, which process comprises separating from the solution a composition comprising: a functionalised polymer, a surfactant and the first charged species, wherein the functionalised polymer comprises groups that bind preferentially to the first charged species and the first charged species is bound to said groups.

The invention also provides a process for removing a first charged species from a modified polymer-surfactant aggregate (modified PSA) which comprises: (i) a polymer-surfactant aggregate (PSA) which comprises a functionalised polymer and a surfactant, and (ii) a first charged species, wherein the functionalised polymer comprises groups that bind preferentially to the first charged species and the first charged species is bound to said groups, which process comprises removing the first charged species from the modified PSA, optionally wherein removing the first charged species from the modified PSA comprises forming a dissolved salt of the first charged species.

### BRIEF DESCRIPTION OF THE FIGURES

FIG. 1 is a graph showing the pH effect on the individual removal of 50 ppm Cu²⁺ and 40 ppm Fe³⁺ using 200 ppm PEI and 2 mM sodium dodecyl sulfate (SDS).

FIG. 2 is a graph showing the pH effect on the removal of 80 ppm Cu²⁺ using PEI with surfactant and PEI on ion exchange resin beads at the same polymer dosage (400 ppm).

FIG. 3 is a graph showing possible surfactant dosages for the removal of 100 ppm Cu²⁺ in 500 ppm Fe³⁺ at pH 2 using 5 mM PEI modified by varying amounts of picolyl chloride.

FIG. 4 is a graph showing possible surfactant dosages for the removal of 100 ppm Cu²⁺ at pH 3 using 800 ppm mono/bis 2-picolylamine modified polyallylamine (PAA) with surfactant. FIG. 5 is a graph showing the pH effect on the removal of 100 ppm Cu²⁺ using PAA and modified PAA using both the polymer-surfactant aggregate (PSA) process of the invention and ion-exchange using PAA fixed on silica ion-exchange beads.

FIG. 6 shows two graphs showing (a) Cu²⁺ removal efficiency and (b) Fe³⁺ removal efficiency, at various surfactant dosages and at 100 ppm Cu²⁺ in 500 ppm Fe³⁺ at pH 2 using varying degrees of 2-picolylamine modified PAA with SDS.

FIG. 7 is a graph showing the removal efficiencies in the treatment cycle for removal of 100 ppm Cu²⁺ in 500 ppm Fe³⁺ at pH 2 using 800 ppm mono 2-picolylamine modified PAA and 5 mM SDS, subsequently recovering Cu²⁺ using a pH=1 solution and the polymer and surfactant using a pH=13 solution.

FIG. 8 is a graph showing the removal efficiencies in the treatment process for the removal of 100 ppm Cu²⁺ in 500 ppm Fe³⁺ at pH 2 using 800 ppm bis 2-picolylamine modified PAA and 4 mM SDS, subsequently recovering Cu²⁺ using 2 M H₂SO₄ solution (pH −0.6).

FIG. 9 is a plot showing the effect of ionic strength (represented as NaCl concentration) on copper removal efficiency using polymer-surfactant aggregates. Cu recovery was found to be unaffected by salinity.

### DETAILED DESCRIPTION OF THE INVENTION

The invention provides a process for selectively removing a first charged species from a plurality of charged species in solution, which process comprises: treating a solution with a functionalised polymer and a surfactant, wherein the solution comprises a plurality of charged species dissolved in a solvent, wherein the plurality of charged species comprises the first charged species and at least one further charged species which is different from the first charged species, and wherein the functionalised polymer comprises groups that bind preferentially to the first charged species.

A key advantage of the invention is the selective removal (and subsequent recovery) of the first charged species.

Typically, “selectively removing” a first charged species from a plurality of charged species in solution means that, when the process is performed, either (i) it removes only the first charged species from the solution and none of the further charged species are removed at the same time, or (ii) the molar amount of the first charged species that is removed from the solution by the process is greater than the molar amount removed of any other charged species that is removed by the process at the same time. Often, in case (ii), the molar amount of the first charged species that is removed from the solution by the process is at least double the molar amount removed of any other charged species in the plurality that is also removed at the same time. It may for instance be at least 10 times, at least 100 times, at least 1,000 times, or at least 10,000 times, the molar amount removed of any other charged species in the plurality that is also removed at the same time. Typically, in case (ii) the molar amount of the first charged species that is removed from the solution by the process is at least double the combined molar amounts removed of all other charged species in the plurality that are also removed by the process at the same time. It may for instance be at least 10 times, at least 100 times, at least 1,000 times, or at least 10,000 times, the combined molar amounts removed of all other charged species in the plurality that are also removed by the process at the same time.

Generally, the first charged species and the at least one further charged species may be any species carrying a positive or a negative charge, such as an organic charged species or an inorganic charged species.

An organic charged species may, for instance, be any organic charged species that could be considered a pollutant. An organic charged species may, for example, be considered a pollutant if it adversely affect human health and/or the environment, e.g. if it find its way into rivers, lakes, seas or effluent from a commercial water treatment plant. Examples of organic charged species include, but are not limited to, agricultural chemicals such as insecticides, pesticides and herbicides, industrial chemicals such as dyes, and drug pollutants such as pharmaceutical drugs and their metabolites.

An inorganic charged species may be any charged species comprising an inorganic species. Examples of inorganic charged species include, but are not limited to, agricultural products such as inorganic fertilizers comprising a nitrate and/or phosphate, and charged species comprising a metal ion. The inorganic charged species may be a species considered to be a pollutant, for instance, a pollutant in industrial waste water. There is, for example, a need to remove metal ions from industrial waste water.

The process is often however used to recover metallic ions from dilute industrial effluent and process streams. It can be used in a wide variety of industries, for the selective removal, recovery and concentration of metal-containing ions from dilute aqueous process streams. Examples of this include (but are by no means limited to); the selective recovery of one or more platinum group metals such as platinum and/or palladium from, for instance, electronic plating baths; the selective recovery of one or more precious metals, such as rhodium, rhenium and iridium, from waste streams during, for instance, the manufacture of catalysts; the selective recovery of copper from, for instance, mixed copper/iron aqueous waste streams, e.g. waste streams in the mining and mineral processing industries; the recovery of heavy metals during the soil washing of contaminated land; and scandium recovery from rare earth processing.

The solution which is treated in the process of the invention comprises said plurality of charged species dissolved in a solvent. The solvent may be a single solvent or a mixture of different solvents.

Usually, the solvent comprises water, i.e. it is usually aqueous. Other solvents may be present in addition to the water, for instance one or more organic solvents. Alternatively, the solvent may consist only of water.

In alternative embodiments of the invention, the solvent may be organic. Thus, the solvent may comprise an organic solvent, or a mixture of organic solvents. The solvent may for instance consist only of an organic solvent, or a mixture of organic solvents. When the solvent comprises an organic solvent, the organic solvent may be a polar organic solvent, for instance a polar protic solvent, such as an alcohol or a carboxylic acid, or a polar aprotic solvent, for instance acetonitrile, acetone or dimethyl sulfoxide (DMSO). Alternatively, the organic solvent may be an apolar organic solvent, for instance a hydrocarbon solvent such as pentane, hexane, toluene or benzene.

Usually, however, the solvent comprises water, i.e. it is aqueous.

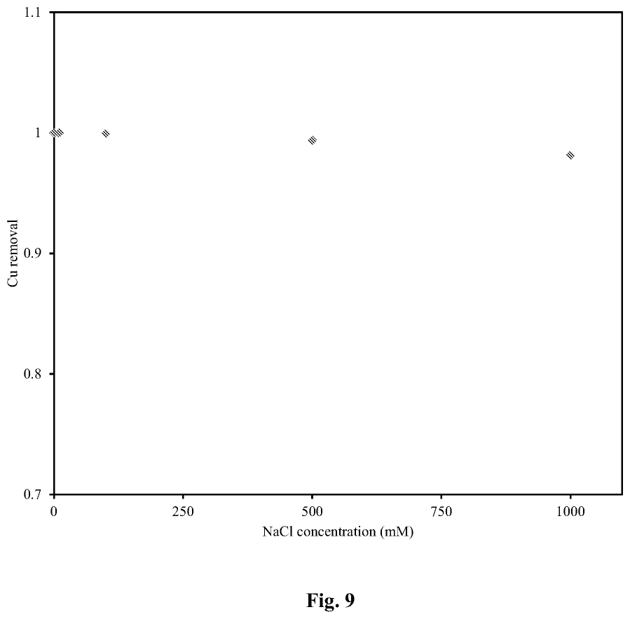

The solution is capable of dissolving the first charged species and the at least one further charged species. These charged species may, for instance, be dissolved in said solution prior to the first process of the invention commencing. The solution may be a natural resource such as a river, lake or sea, and/or may comprise wastewater from an agricultural or industrial process. The solution may for instance be an industrial effluent or a process stream, for instance a dilute aqueous process stream. The solution may for instance be the contents of an electronic plating baths, or for instance a waste stream produced during an industrial process (e.g. in the manufacture of catalysts), or it may for example be a mixed copper/iron aqueous waste stream. The solution may for instance be a solution which further comprises a salt, for instance an aqueous NaCl solution, such as seawater. Advantageously, the process of the invention has been found to be unaffected by salinity, as shown for example in FIG. 9 hereinbelow.

In the process of the invention, the surfactant and the functionalised polymer may be added in any order. Thus, the process may comprise treating the solution with a surfactant and then treating the solution with a functionalised polymer, or treating the solution with a surfactant and a functionalised polymer simultaneously, or treating the solution with a functionalised polymer and then treating the solution with a surfactant.

A key advantage of the process of the invention is the selective removal of the first charged species present in the system, which is aided by competitive adsorption between the first charged species and the polymer functional groups, namely the groups that bind preferentially to the first charged species.

The term “a group that binds preferentially to the first charged species”, as used herein, means a group that binds to the first charged species in the solution in preference to the at least one further charged species in the solution. It is typically, therefore, a group to which the first charged species has a greater binding affinity than any of the at least one further charged species in the solution. There is typically a greater attractive force between the first charged species and the group that binds preferentially to the first charged species, than there is between any of the at least one further charged species in the solution and the group that binds preferentially to the first charged species. The group that binds preferentially to the first charged species is typically therefore capable of binding more strongly to the first charged species than to any of the at least one further charged species. This generally results in the first charged species having a higher degree of occupancy at the groups that bind preferentially to the first charged species, than any of the at least one further charged species in the solution. The presence of the groups that bind preferentially to the first charged species therefore enable selective removal of the first charged species in accordance with the invention.

Groups that bind preferentially to the first charged species may be selected according to the first charged species that it is desired to remove. The skilled person is aware of a variety of particular functional groups that bind preferentially to particular charged species. The skilled person is readily able to select a particular functional group for binding preferentially to a particular first charged species, and then obtain or synthesise a polymer which bears that particular functional group for use in accordance with the invention. Many polymers bearing such functional groups are already known or commercially available, for instance mono 2-picolylamine modified poly(allylamine) (PAA) and bis 2-picolylamine modified PAA are available commercially. In addition, the skilled person is readily able to synthesise polymers bearing such functional groups using routine polymer synthesis methods. Functional groups can be attached to polymers using routine coupling chemistry. The groups that bind preferentially to the first charged species are typically attached to the polymer backbone. Attachment of the functional groups (or attachment of a protected version thereof, followed by deprotection at a later point) can be carried out either prior to polymerisation or after polymerisation. Thus, a functional group that binds preferentially to the first charged species (or a protected version thereof) may be attached to a monomer unit and then polymerisation of the monomer may subsequently be performed. If necessary, deprotection of a protected version of the functional group may then be performed, after the polymerisation. Alternatively, a functional group that binds preferentially to the first charged species (or a protected version thereof) may be attached to a polymer after polymerisation, for instance by attaching the groups to the polymer backbone. Deprotection may then be performed if necessary to render the polymer bearing the functional groups that bind preferentially to the first charged species.

Each functional group that binds preferentially to the first charged species may be any suitable group that is capable of binding to the first charged species in the solution in preference to any of the at least one further charged species in the solution. The groups that bind preferentially to the first species may for instance comprise chelating groups, capable of chelation to the first charged species in preference to any of the at least one further charged species. Alternatively, they may comprise charged groups or polar groups. Such groups may be capable of bonding electrostatically to the first charged species in preference to any of the at least one further charged species. Generally a charged group will have a charge of opposite polarity to the first charged species. In general, the functional group will have the property that it has a specific and selective affinity for binding with the first charged species which is relatively stronger than that with any of the at least one further charged species in the solution.

Often, each of the groups that binds preferentially to the first charged species comprises at least one donor atom that is capable of bonding to the first charged species. The donor atom may be carbon or a heteroatom, for instance nitrogen, oxygen, phosphorus or sulphur. Often, the donor atom is nitrogen.

Often, the groups that bind preferentially to the first charged species comprise chelating groups. The groups that bind preferentially to the first species may for instance comprise bidentate, tridentate or polydentate chelating groups, or macrocyclic groups. Examples of macrocyclic groups are porphyrins and cryptands.

Each chelating group generally comprises at least two donor atoms, which are the same or different, that are capable of bonding to the first charged species. The donor atoms may be selected from carbon and heteroatoms, for instance nitrogen, oxygen, phosphorus and sulphur. Often, the at least two donor atoms are both heteroatoms. The at least two donor atoms may for instance be selected from nitrogen, oxygen, phosphorus and sulphur. Often, the at least two donor atoms comprise a (i.e. at least one) nitrogen atom. Typically, the at least two donor atoms are nitrogen atoms. The at least two donor atoms may comprise a (i.e. at least one) sulphur atom. Thus, the at least two donor atoms may be sulphur atoms.

The groups that bind preferentially to the first species typically comprise bidentate or tridentate chelating groups.

Often, for instance, the groups that bind preferentially to the first species typically comprise bidentate chelating groups. Each bidentate chelating group generally comprises two donor atoms, which are the same or different, that are capable of bonding to the first charged species. The two donor atoms may be selected from carbon and heteroatoms, for instance nitrogen, oxygen, phosphorus and sulphur. Often, the two donor atoms are both heteroatoms. The two donor atoms may for instance be selected from nitrogen, oxygen, phosporhus and sulphur. Often, the two donor atoms are both nitrogen. In other embodiments, however, the donor atoms of the bidentate chelating group comprise sulphur atoms, and for instance both donor atoms of the bidentate chelating group may be sulphur.

Alternatively, the groups that bind preferentially to the first species may comprise tridentate chelating groups. Each tridentate chelating group generally comprises three donor atoms, which are the same or different, that are capable of bonding to the first charged species. The three donor atoms may be selected from carbon and heteroatoms, for instance nitrogen, oxygen, phosphorus and sulphur. Often, the three donor atoms are all heteroatoms. The three donor atoms may for instance be selected from nitrogen, oxygen, phosphorus and sulphur. Often, the three donor atoms are all nitrogen. In other embodiments, however, the donor atoms of the tridentate chelating group comprise sulphur atoms, and the three donor atoms of the tridentate chelating group may for instance all be sulphur.

Another alternative is that the groups that bind preferentially to the first species comprise both bidentate chelating groups and tridentate chelating groups. Each bidentate chelating group generally comprises two donor atoms, which are the same or different, that are capable of bonding to the first charged species, and each tridentate chelating group generally comprises three donor atoms, which are the same or different, that are capable of bonding to the first charged species. The donor atoms of the bidentate and tridentate chelating groups may be as further defined above. Often, the donor atoms of the bidentate and tridentate chelating groups are all heteroatoms. The donor atoms of the bidentate and tridentate chelating groups may all for instance be selected from nitrogen, oxygen, phosphorus and sulphur. Often, the donor atoms of the bidentate and tridentate chelating groups are all nitrogen. In other embodiments, however, the donor atoms of the bidentate and tridentate chelating groups comprise sulphur atoms, and may all be sulphur.

In addition to the donor atoms, which as mentioned above are often heteroatoms but may be carbon, chelating groups typically comprise an organic hydrocarbon moiety to give the chelating group its chelating structure. The organic hydrocarbon moiety typically comprise aliphatic hydrocarbon (e.g. alkyl) groups and/or aromatic (e.g. phenyl) groups, to give the chelating group its chelating structure.

Many chelating groups are known to the skilled person that could be employed in the present invention as the groups that bind preferentially to the first species. These include, for instance chelating groups which comprise a 2-picolyl group bonded to a nitrogen atom, i.e. chelating groups which comprise the following moiety:

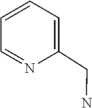

Such a moiety may be part of a bidentate group. Alternatively, such a moiety may be part of a tridentate group, e.g. when two 2-picolyl groups are bonded to the same nitrogen atom, as follows:

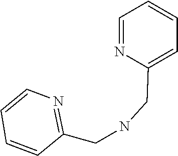

Thus, the chelating groups may comprise bidentate chelating groups of the following structure:

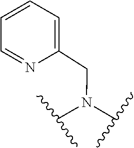 [SMILES: *N(*)Cc1ccccn1]

Alternatively, the chelating groups may comprise tridentate chelating groups of the following structure:

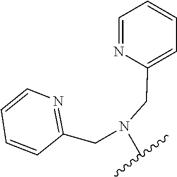 [SMILES: *N(Cc1ccccn1)Cc1ccccn1]

The chelating groups may for instance comprise both bidentate and tridentate groups of the following structures

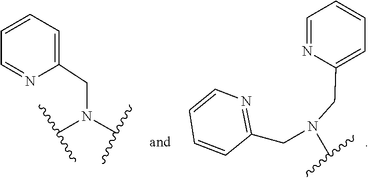 [SMILES: *N(*)Cc1ccccn1 ; *N(Cc1ccccn1)Cc1ccccn1]

The groups that bind preferentially to the first charged species may comprise mono-2-picolyl amine groups or bis-2-picolyl amine groups. The groups that bind preferentially to the first charged species may comprise both mono-2-picolyl amine groups and bis-2-picolyl amine groups.

Many other groups are known to the skilled person that could be employed in the present invention as the groups that bind preferentially to the first species.

These include, for example groups that comprise sulphur donor atoms, for instance thiol groups. Chelating groups that comprise at least one sulphur donor atom, for instance at least one thiol group, may for instance be employed.

As discussed above, the process is typically performed on an aqueous solvent.

The functionalised polymer is typically therefore a hydrophilic polymer.

Often, the functionalised polymer is a polymer comprising ionisable groups.

The term “polymer comprising ionisable groups”, as used herein, refers to any polymer comprising a functional group that is ionised or that is capable of being ionised, i.e. a functional group that can carry a charge. If, for example, the polymer is in solution, a change in the pH of the solution may be necessary for the functional group to become charged. The term “polymer comprising ionisable groups” therefore encompasses anionic polymers (i.e. a polymer comprising a negatively charged functional group), cationic polymers (i.e. a polymer comprising a positively charged functional group) and polyelectrolytes (i.e. a polymer comprising a functional group that can ionise in solution). A polymer comprising ionisable groups may be a polymer comprising two or more different ionisable groups. The term “polymer comprising ionisable groups” therefore also encompasses ampholytic polymers. The term ampholytic polymer, as used herein, refers to a polyelectrolyte comprising macromolecules containing both cationic and anionic groups, or corresponding ionizable groups. An ampholytic polymer in which ionic groups of opposite sign are incorporated into the same pendant groups may be called, depending on the structure of the pendant groups, a zwitterionic polymer, polymeric inner salt, or polybetaine.

When the functionalised polymer is a polymer comprising ionisable groups, the ionisable groups in the polymer may be different from the groups in the polymer that bind preferentially to the first species. Alternatively, the groups that bind preferentially to the first species may be the same as the ionisable groups. Another alternative is where the groups that bind preferentially to the first species may include the ionisable groups within their structure. An example of this latter case would be where the groups that bind preferentially to the first species are chelating groups that comprise nitrogen donor atoms, where the nitrogen donor atoms in the chelating groups are also ionisable, to provide cationic nitrogen atoms.

The ionisable groups may for instance comprise primary, secondary, tertiary or quaternary amine groups.

The functionalised polymer may be a positively charged polymer when in solution, typically when in aqueous solution. In particular, the functionalised polymer may be one which is a positively charged polymer when in aqueous solution, when the solution is at a pH which is less than the isoelectric point of the functionalised polymer. The functionalised polymer may for instance be a polyamine which is functionalised to provide said groups that bind preferentially to the first charged species, for instance it may be polyethylenimine (PEI) or polyallylamine (PAA), which is functionalised to provide said groups that bind preferentially to the first charged species. The functionalised polymer may for instance be a polymer which comprises primary, secondary, tertiary or quaternary amine groups, provided of course that the polymer is functionalised to provide said groups that bind preferentially to the first charged species. Examples of polymers comprising quaternary nitrogens include, for instance polydiallyldimethylammonium chloride (PDADMAC), poly(1-methyl-4-vinylpyridinium bromide) or poly(1-methyl-2-vinylpyridinium bromide). A polymers comprising a quaternary nitrogen may be employed in the present invention, provided of course that the polymer is functionalised to provide said groups that bind preferentially to the first charged species. Such positively charged polymers are typically employed when the first charged species and the at least one further charged species are positively charged species. Such positively charged polymers are typically employed when the surfactant is an anionic surfactant. Such positively charged polymers are in particular typically employed when the first charged species and the at least one further charged species are positively charged species, and the surfactant is an anionic surfactant.

Alternatively, the functionalised polymer may be a negatively charged polymer when in solution, typically when in aqueous solution. In particular, the functionalised polymer may be one which is a negatively charged polymer when in aqueous solution, when the solution is at a pH which is greater than the isoelectric point of the functionalised polymer. The functionalised polymer may for instance be an organic polymer comprising a carboxyl group or a sulfonate group, which polymer is also functionalised to provide said groups that bind preferentially to the first charged species. Examples of organic polymers comprising carboxyl groups which can be employed include, but are not limited to, polyolefins substituted with carboxyl groups, polyesters substituted with carboxyl groups and polysulfides substituted with carboxyl groups. Suitable organic polymers comprising carboxyl groups include polyacrylic acid, poly(alkyl)acrylic acids, such as poly(meth)acrylic acid, and poly(alkyl)acrylic (alkyl)acids, such as poly(methyl methactylate), and salts thereof, provided of course that the polymer is also functionalised to provide said groups that bind preferentially to the first charged species. Examples of organic polymers comprising sulfonate groups can be include, but are not limited to, polyolefins substituted with sulfonate groups, polyesters substituted with sulfonate groups, polysulfides substituted with sulfonate groups, and poly(sodium styrene sulfonate), provided of course that the polymer is also functionalised to provide said groups that bind preferentially to the first charged species. Such negatively charged polymers are typically employed when the surfactant is a cationic surfactant. Such negatively charged polymers are in particular typically employed when the first charged species and the at least one further charged species are negatively charged species, and the surfactant is a cationic surfactant, i.e. in what is referred to herein as the “mirror image system” (as opposed to the more usual situation, of the kind described in the Example herein, where the first charged species and the at least one further charged species are positively charged species, and the surfactant is an anionic surfactant).

Often, the polymer is a positively charged polymer when in solution.

The functionalised polymer may for instance comprise primary, secondary, tertiary or quaternary amine groups.

Often, for instance, the functionalised polymer is a polyamine which is functionalised to provide said groups that bind preferentially to the first charged species. The polyamine may for instance be polyethylenimine (PEI) or polyallylamine (PAA). The polyamine may for instance be polyethylenimine (PEI). Alternatively, the polyamine may polyallylamine (PAA). The polyamine may be functionalised to provide mono-2-picolyl amine groups, as groups that bind preferentially to the first charged species. The polyamine may be functionalised to provide bis-2-picolyl amine groups, as groups that bind preferentially to the first charged species. The polyamine may be functionalised to provide both mono-2-picolyl amine groups and bis-2-picolyl amine groups, as groups that bind preferentially to the first charged species. The polyamine may for instance be functionalised to provide either or both of the following groups, as groups that bind preferentially to the first charged species:

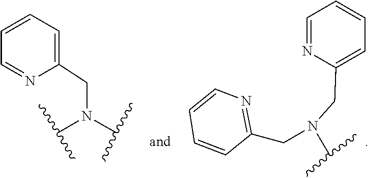 [SMILES: *N(*)Cc1ccccn1 ; *N(Cc1ccccn1)Cc1ccccn1]

The functionalised polymer may for instance comprise polyethylenimine (PEI) functionalised with 2-picolyl groups. Thus, the functionalised polymer may comprise N-(2-picolyl)-substituted PEI.

Typically, the functionalised polymer comprises functionalised units of formula (X), functionalised units of formula (Y), and/or functionalised units of formula (Z)

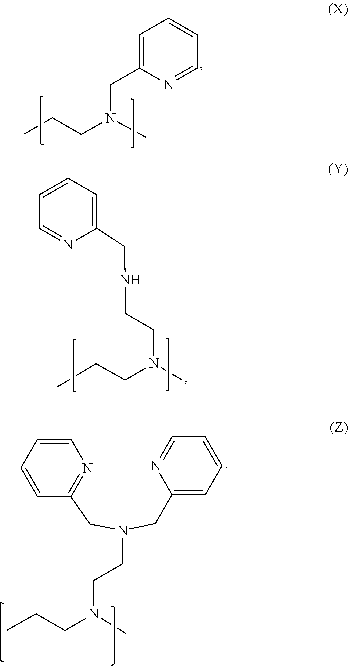

Such functionalised units, in which a nitrogen atom has been substituted with at least one 2-picolyl group, are typically present in the functionalised PEI which may be employed in the present invention. However, not all units in the PEI will necessarily be functionalised with picolyl groups; unreacted units will typically also be present.

Accordingly, the functionalised polymer may further comprise unfunctionalised units of formula (V) and/or unfunctionalised units of formula (W)

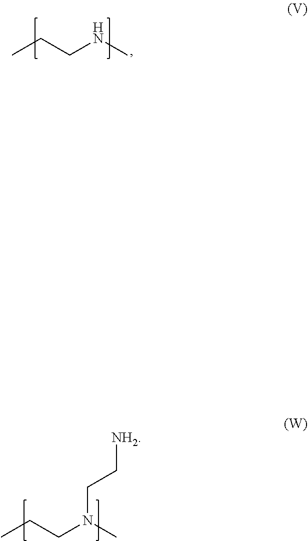

As mentioned above, the functionalised polymer may for instance comprise polyethylenimine (PEI) functionalised with 2-picolyl groups.

Typically, in such polymers, the ratio of 2-picolyl groups per nitrogen atom in the PEI is at least 0.2:1, optionally from 0.2:1 to 1:1. The ratio of 2-picolyl groups per nitrogen atom in the PEI may for instance be at least 0.5:1, and may optionally be from 0.5:1 to 1:1. Indeed, it has been demonstrated herein that selective removal of Cu²⁺ from Fe³⁺ at pH 2 can be achieved by modifying PEI with picolyl chloride at a molar ratio of from 0.2:1, preferably 0.5:1, picolyl chloride to PEI monomer.

The functionalised polymer may be a polymer obtainable by treating polyethylenimine (PEI) with 2-picolyl chloride, or with a salt of 2-picolyl chloride, for instance with 2-picolyl chloride hydrochloride. Typically, the functionalised polymer is obtainable by treating polyethylenimine (PEI) with 2-picolyl chloride or a salt thereof in a molar ratio of picolyl chloride (or a salt thereof) to PEI monomer unit of at least 0.2:1, optionally from 0.2:1 to 1:1.

The functionalised polymer may be obtainable by treating polyethylenimine (PEI) with 2-picolyl chloride (or a salt thereof) in a molar ratio of picolyl chloride to PEI monomer unit of at least 0.5:1, optionally from 0.5:1 to 1:1.

The functionalised polymer may be a polymer obtainable by treating polyethylenimine (PEI) with 2-picolyl chloride, or with a salt of 2-picolyl chloride, for instance with 2-picolyl chloride hydrochloride. Typically, the functionalised polymer is obtainable by treating polyethylenimine (PEI) with 2-picolyl chloride or a salt thereof in a molar ratio of picolyl chloride (or a salt thereof) to PEI monomer unit of at least 0.2:1, optionally from 0.2:1 to 1:1.

The functionalised polymer may be obtainable by treating polyethylenimine (PEI) with pyridine-2-carboxaldehyde (or a salt thereof) in a molar ratio of pyridine-2-carboxaldehyde (or a salt thereof) to PEI monomer unit of at least 0.5:1, optionally from 0.5:1 to 1:1.

In another embodiment, the functionalised polymer comprises poly(allylamine) (PAA) functionalised with 2-picolyl groups. The functionalised polymer may for instance comprise N-(2-picolyl)-substituted PAA.

Often, the functionalised polymer comprises functionalised units of formula (I) and/or functionalised units of formula (II)

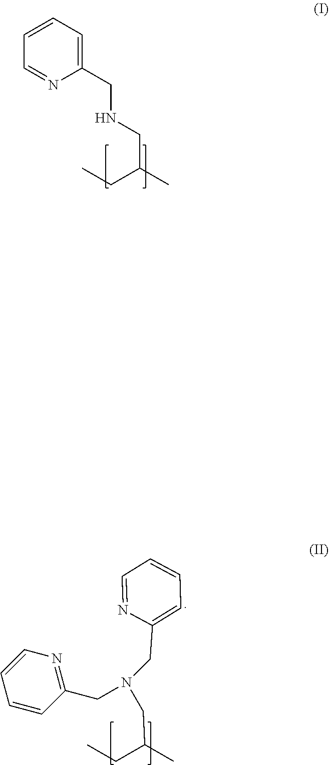

Such functionalised units, in which a nitrogen atom has been substituted with at least one 2-picolyl group, are typically present in the functionalised PAA which may be employed in the present invention. However, not all units in the PAA will necessarily be functionalised with picolyl groups; unreacted units will typically also be present.

Accordingly, the functionalised polymer may further comprise unfunctionalised units of formula (III)

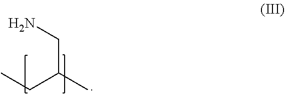

As the skilled person would appreciate, unfunctionalised units will typically be present. However, a polymer which is 100% functionalised would give the maximum separative power. Thus, in the cases outlined above, the higher functional group-to-monomer ratio is preferable.

The functionalised polymer may comprise mono 2-picolylamine modified PAA, which comprises units of formula (I)

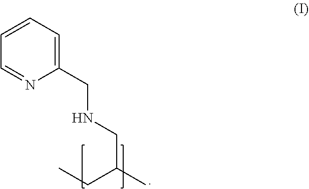

The functionalised polymer may comprise bis 2-picolylamine modified PAA, which comprises units of formula (II)

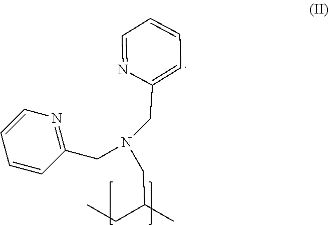

Typically, the ratio of 2-picolyl groups per nitrogen atom in the PAA is at least 0.2:1, optionally from 0.2:1 to 2:1; preferably wherein the ratio of 2-picolyl groups per nitrogen atom in the PAA is at least 0.5:1, optionally from 0.5:1 to 2:1.

The ratio of 2-picolyl groups per nitrogen atom in the PAA may be at least 1:1. Often, it is from 1:1 to 2:1.

In some embodiments, the functionalised polymer is obtainable by treating polyallylamine (PAA) with 2-picolyl chloride, or with a salt of 2-picolyl chloride, for instance with 2-picolyl chloride hydrochloride. The functionalised polymer may be obtainable by treating polyallylamine (PAA) with 2-picolyl chloride or a salt thereof in a molar ratio of picolyl chloride (or salt thereof) to PAA monomer unit of at least 0.2:1. The molar ratio of picolyl chloride (or salt thereof) to PAA monomer unit may optionally be from 0.2:1 to 2:1, and the molar ratio of picolyl chloride (or salt thereof) to PAA monomer unit is preferably at least 0.5:1, for instance from 0.5:1 to 2:1.

The functionalised polymer may for instance be obtainable by treating polyallylamine (PAA) with 2-picolyl chloride (or a salt thereof) in a molar ratio of picolyl chloride to PAA monomer unit of at least 1:1, optionally from 1:1 to 2:1.

Indeed, it has been demonstrated herein that selective removal of Cu²⁺ from Fe³⁺ at pH 2 is achieved by modifying PAA with picolyl chloride at a molar ratio of 0.2:2, preferably 0.5:2, more preferably 1:2, most preferably 2, picolyl chloride to PAA monomer unit.

Alternatively, the functionalised polymer may be obtainable by treating polyallylamine (PAA) with pyridine-2-carboxaldehyde (or a salt thereof). The functionalised polymer may be obtainable by treating polyallylamine (PAA) with pyridine-2-carboxaldehyde (or a salt thereof) in a molar ratio of pyridine-2-carboxaldehyde (or a salt thereof) to PAA monomer unit of at least 0.2:1. The molar ratio of pyridine-2-carboxaldehyde (or a salt thereof) to PAA monomer unit may optionally be from 0.2:1 to 2:1, and the molar ratio of pyridine-2-carboxaldehyde (or a salt thereof) to PAA monomer unit is preferably at least 0.5:1, for instance from 0.5:1 to 2:1.

The functionalised polymer may for instance be obtainable by treating polyallylamine (PAA) with pyridine-2-carboxaldehyde (or a salt thereof) in a molar ratio of picolyl chloride to PAA monomer unit of at least 1:1, optionally from 1:1 to 2:1.

The process of the invention employs a surfactant. The term surfactant, as used herein, refers to an amphiphilic compound comprising a hydrophobic group and a hydrophilic group. A surfactant may thus be a compound which comprises both a water soluble component and a water insoluble component. The hydrophobic group of a surfactant is often referred to as the tail group. The tail usually comprises a hydrocarbon chain, i.e. a chain comprising carbon atoms, which may be branched, linear or aromatic in nature. The hydrophilic group of a surfactant is often referred to as the head group. The head usually comprises an ionic functional group, such as an anionic functional group or a cationic functional group, but the head group may alternatively be a non-ionic group. The surfactant may comprise one or more hydrophobic groups, for instance the surfactant may comprise one or two hydrophobic groups. Typically, a surfactant reduces the surface tension of a liquid to which it is added. A surfactant may, for instance, be a non-natural surfactant. Examples of surfactants include sodium dodecyl sulphate (SDS), Myristyltrimethylammonium chloride and Myristyltrimethylammonium bromide (which can be abbreviated to C₁₄TAB or MTAB).

In the process of the invention, the surfactant is typically an ionic surfactant. In such embodiments, the surfactant is generally an anionic surfactant when the first charged species and the at least one further charged species are positively charged species. On the other hand, in the “mirror image system” when the first charged species and the at least one further charged species are negatively charged species, the ionic surfactant is generally a cationic surfactant.

The ionic surfactant typically comprises a hydrocarbon chain terminating in an ionic functional group. An anionic surfactant is typically a compound comprising a hydrocarbon chain terminating in an anionic functional group. The hydrocarbon chain may be an unsubstituted C₅-C₃₅ alkyl group. A cationic surfactant is typically a compound comprising a hydrocarbon chain terminating in a cationic functional group, e.g. a cationic functional group bonded to an unsubstituted C₅-C₃₅ alkyl group.

As mentioned above, typically, when the first charged species and the at least one further charged species are positively charged species, the surfactant is an anionic surfactant.

The anionic surfactant may, for instance, comprise an anionic functional group selected from a sulphate, sulfonate, phosphate, phosphonate and carboxylate group. For instance, the anionic surfactant comprises a sulphate group.

As used herein, the term “sulphate” represents a group of formula: —SO₄²⁻. As would be understood by the skilled person, a sulphate group can exist in protonated and deprotonated forms (for example, —SO₄H⁻ or —SO₄²⁻), and in salt forms (for example, —SO₄X⁺, wherein X⁺ is a monovalent cation). X⁺ may for instance be an alkali metal cation or a cationic alkaline earth metal monohydroxide. Thus, X⁺ may be Na⁺, K⁺, [CaOH]⁺ or [MgOH]⁺, for instance.

As used herein, the term “sulfonate” represents a group of formula: —S(═O)₂O⁻. As would be understood by the skilled person, a sulfonate group can exist in protonated and deprotonated forms (for example, —S(O)₂OH or —S(═O)₂O⁻), and in salt forms (for example, —S(O)₂O⁻X⁺, wherein X⁺ is a monovalent cation). X⁺ may for instance be an alkali metal cation or a cationic alkaline earth metal monohydroxide. Thus, X⁺ may be Na⁺, K⁺, [CaOH]⁺ or [MgOH]⁺, for instance.

As used herein, the term “phosphate” represents a group of formula: —PO₄³⁻. As would be understood by the skilled person, a phosphate group can exist in protonated and deprotonated forms (for example, —PO₄H²⁻, —PO₄H₂⁻ or —PO₄³⁻), and in salt forms (for example, —PO₄X²⁻ or —PO₄X₂⁻, wherein X⁺ is a monovalent cation). X⁺ may for instance be an alkali metal cation or a cationic alkaline earth metal monohydroxide. Thus, X⁺ may be Na⁺, K⁺, [CaOH]⁺ or [MgOH]⁺, for instance.

As used herein, the term “phosphonate” represents a group of formula: —PO(OR)₂⁻, wherein R is, for example, hydrogen or a C₁-C₆ alkyl group. As would be understood by the skilled person, a phosphonate group can exist in protonated and deprotonated forms (for example, —PO(OR)₂H of —PO(OR)₂⁻, and in salt forms (for example, —PO(OR)₂X, wherein X⁺ is a monovalent cation). X⁺ may for instance be an alkali metal cation or a cationic alkaline earth metal monohydroxide. Thus, X⁺ may be Na⁺, K⁺, [CaOH]⁺ or [MgOH]⁺, for instance.

As used herein, the term “carboxyl” represents a group of the formula: —C(═O)O⁻, or —COO⁻. As would be understood by the skilled person, a carboxyl group can exist in protonated and deprotonated forms (for example, —C(═O)OH and —C(═O)O⁻), and in salt forms (for example, —C(═O)O⁻X⁺, wherein X⁺ is a monovalent cation). X⁺ may for instance be an alkali metal cation or a cationic alkaline earth metal monohydroxide. Thus, X⁺ may be Na⁺, K⁺, [CaOH]⁺ or [MgOH]⁺, for instance.

Typically, the anionic surfactant comprises an alkyl chain comprising from 5 to 35 carbon atoms, for instance, from 5 to 25 carbon atoms. Thus, the alkyl chain may be an unsubstituted or substituted C₅-C₃₅ alkyl group as defined herein. Usually, the anionic surfactant comprises an alkyl chain comprising from 5 to 20 carbon atoms (C₅-C₂₀ alkyl group), for instance, from 5 to 15 carbon atoms (C₅-C₁₅ alkyl group). For instance, the anionic surfactant may comprise an alkyl chain comprising from 10 to 15 carbon atoms (C₁₀-C₁₅ alkyl group). Typically, the alkyl group is unsubstituted. Thus, the surfactant may be a compound comprising an ionic functional group bonded to an unsubstituted C₅-C₃₅ alkyl group.

The anionic surfactant may, for instance, comprise a cation, for instance a nitrogen-containing cation such as ammonium or a group I cation such as sodium.

The anionic surfactant may, for instance, be an alkylbenzene sulfonate, an alkyl sulphate, an alkyl ether sulphate or a soap. Examples include ammonium lauryl sulphate, dioctyl sodium sulfosuccinate, potassium lauryl sulphate, soap, sodium dodecyl sulphate (SDS), sodium dodecylbenzenesulfonate, sodium laureth sulphate, sodium lauroyl sarcosinate, sodium myreth sulphate, sodium pareth sulphate, and sodium stearate. The anionic surfactant may, for instance, be sodium dodecyl sulphate (SDS).

Often, in the process of the invention, the surfactant is an anionic surfactant. Typically, the surfactant is sodium dodecyl sulfate (SDS).

As mentioned above, alternatively, and typically when the first charged species and the at least one further charged species are negatively charged species, the surfactant may be a cationic surfactant.

Typically, the cationic surfactant comprises (a) a cationic functional group comprising a quaternary nitrogen or (b) a cationic nitrogen-containing group wherein the nitrogen is not a quaternary nitrogen.

As used herein, a cationic nitrogen-containing group is a group wherein the nitrogens are not quaternary nitrogens, such as protonated monodentate primary, secondary and tertiary amino groups, i.e. —NH₃, —NHR₂, and —NH₂R, and protonated bidentate secondary and tertiary amines, i.e. —N⁺RH— and —NH₂—. As the skilled person will appreciate, the cationic nitrogen-containing groups will usually only be cationic if in acidic conditions (i.e. pH of less than 7).

When the cationic surfactant comprises a quaternary nitrogen, the quaternary nitrogen typically has the formula: (NR₁R₂R₃R₄)⁺, wherein R₁, R₂, R₃ and R₄ are independently selected from a substituted or unsubstituted alkyl group or a substituted or unsubstituted alkenyl group.

As used herein, an alkyl group can be a substituted or unsubstituted, linear or branched chain saturated radical, it is often a substituted or an unsubstituted linear chain saturated radical, more often an unsubstituted linear chain saturated radical. The alkyl group may, for instance, it may be a C₁-C₃₅ alkyl group, which is an alkyl group having 1 to 35 carbon atoms, for instance, a C₁-C₃₀ alkyl group, which is an alkyl group having 1 to 30 carbon atoms. A C₁-C₂₀ alkyl group is an unsubstituted or substituted, straight or branched chain saturated hydrocarbon radical. For instance, a C₁-C₁₀ alkyl, for example methyl, ethyl, propyl, butyl, pentyl, hexyl, heptyl, octyl, nonyl or decyl, or C₁-C₆ alkyl, for example methyl, ethyl, propyl, butyl, pentyl or hexyl, or C₁-C₄ alkyl, for example methyl, ethyl, i-propyl, n-propyl, t-butyl, s-butyl or n-butyl. A C₅-C₃₅ alkyl group it is a substituted or unsubstituted, linear or branched chain saturated radical having from 5 to 35 carbon atoms. For instance a “C₅-C₃₅ alkyl group” is a substituted or unsubstituted linear chain saturated radical, often an unsubstituted linear chain saturated radical. Preferably a substituted or unsubstituted C₅-C₃₅ alkyl group is a substituted or unsubstituted C₈-C₁₈ alkyl group. Suitable alkyl groups include octyl, nonyl, decyl, dodecyl, hexadecyl, heptadecyl and octadecyl. A C₁-C₆ alkyl radical has from 1 to 6 carbon atoms, suitable alkyl groups include methyl, ethyl, n-propyl, i-propyl, n-butyl, sec-butyl and tert-butyl, as well as pentyl, e.g. CH₂C(CH₃)₃, and hexyl, preferably it is C₁-C₄ alkyl, for example methyl, ethyl, propyl, i-propyl, n-propyl, butyl, t-butyl, s-butyl or n-butyl.

As used herein, an alkenyl group or moiety can be linear, branched or cyclic but is preferably linear. It contains one or more carbon-carbon double bonds. The alkenyl group may, for instance, be a C₂-C₃₀ alkenyl group, for instance, a C₅-C₂₀ alkenyl group.

When an alkyl or an alkenyl group is substituted it typically bears one or more substituents selected from substituted or unsubstituted C₁-C₂₀ alkyl, substituted or unsubstituted aryl (as defined herein), cyano, amino, C₁-C₁₀ alkylamino, di(C₁-C₁₀)alkylamino, arylamino, diarylamino, arylalkylamino, amido, acylamido, hydroxy, oxo, halo, carboxy, ester, acyl, acyloxy, C₁-C₂₀ alkoxy, aryloxy, haloalkyl, sulfonic acid, sulthydryl (i.e. thiol, —SH), C₁-C₁₀ alkylthio, arylthio, sulfonyl, phosphoric acid, phosphate ester, phosphonic acid and phosphonate ester. Examples of substituted alkyl groups include haloalkyl, hydroxyalkyl, aminoalkyl, alkoxyalkyl and alkaryl groups. The term alkaryl, as used herein, pertains to a C₁-C₂₀ alkyl group in which at least one hydrogen atom has been replaced with an aryl group. Examples of such groups include, but are not limited to, benzyl (phenylmethyl, PhCH₂—), benzhydryl (Ph₂CH—), trityl (triphenylmethyl, Ph₃C—), phenethyl (phenylethyl, Ph—CH₂CH₂—), styryl (Ph—CH═CH—), cinnamyl (Ph—CH═CH—CH₂—). Typically a substituted alkyl group carries 1, 2 or 3 substituents, for instance 1 or 2 substituents.

Usually, when the cationic surfactant comprises a quaternary nitrogen, the quaternary nitrogen typically has the formula: (NR₁R₂R₃R₄)⁺, wherein R₁, R₂, R₃ and R₄ are independently selected from a substituted or unsubstituted C₁-C₃₀ alkyl group.

Typically, R₁, R₂ and R₃ are independently selected from a substituted or unsubstituted C₁-C₆ alkyl group and R₄ is a substituted or unsubstituted C₁₀-C₃₀ alkyl group. For instance, R₁, R₂ and R₃ may be independently selected from a substituted or unsubstituted C₁-C₄ alkyl group and R₄ may be a substituted or unsubstituted C₁₀-C₂₀ alkyl group. Usually, R₁, R₂ and R₃ are independently selected from a substituted or unsubstituted C₁-C₃ alkyl group such as methyl or ethyl, for instance methyl, and R₄ is a substituted or unsubstituted C₁₀-C₂₀ alkyl group, for instance R₄ a substituted or unsubstituted C₁₅-C₂₀ alkyl group.

The cationic surfactant may, for instance, comprise a anion, for instance a halide such as a fluoride, chloride, bromide or iodide anion. Typically, the anion is a chloride anion or a bromide anion, for instance a bromide anion.

The cationic surfactant may, for instance, be selected from a benzalkonium chloride, Myristyltrimethylammonium bromide (C₁₄TAB or MTAB) and Myristyltrimethylammonium chloride. The cationic surfactant may, for instance, be Myristyltrimethylammonium bromide (C₁₄TAB, or MTAB).

In terms of the first charged species and the at least one further charged species, as discussed above these may be selected from organic charged species and inorganic charged species, and, for instance metallic species.

Often, the first charged species and the at least one further charged species are metallic species, i.e. metallic ions. A metallic ion is a metal-containing ion. This may for instance be (i) a monatomic metal ion, or (ii) a polyatomic ion in which at least one of the atoms is a metal atom. Thus, a metallic ion may for instance be a metal anion or a metal cation; or a complex anion which comprises a metal, such as for instance chromate, dichromate, ferricyanide and permanganate, or indeed a complex cation which comprises a metal.

Often, the first charged species and the at least one further charged species are different metal ions.

In terms of the charges of the first charged species and the at least one further charged species, these are generally of the same polarity. In other words, it is generally the case that the process separates a positively charged species from one or more other positively charged species, or alternatively the process separates a negatively charged species from one or more other negatively charged species.

Often, the first charged species and the at least one further charged species are positively charged species. Alternatively, however, the first charged species and the at least one further charged species may be negatively charged species.

Any charged species may be monovalent (i.e. it may be a monocation or a monoanion) or it may have a valency of two or more, for instance, a valency of two, three, four, five or six (i.e. it may be a dication, trication, tetracation, pentacation or hexacation, or it may be a dianion, trianion, tetraanion, pentaanion or hexaanion).

The valency of the first charged species and the at least one further charged species need not be the same. However, a particular advantage of the invention is that it is able selectively to separate a charged species of a particular charge from other charged species of the same charge. In some embodiments, therefore, the first charged species and a further charged species, have the same valency, i.e. the same charge. Thus, in some cases, the first charged species and the at least one further charged species, may have the same valency, i.e. the same charge.

When the first charged species and the at least one further charged species are positively charged species, they can in principle be any combination of positively charged species in which one of the positively charged species is one that is desired to be removed and recovered from the other positively charged species, selectively, by the process of the invention.

The first charged species and the at least one further charged species may for instance be metallic cations. A metallic cation is a metal-containing cation. This includes (i) monatomic metal cations, or (ii) polyatomic cations in which at least one of the atoms is a metal, in other words complex cations which comprise a metal. Thus, the first charged species and the at least one further charged species may be selected from metal cations and complex cations which comprise a metal.

Often, the first charged species and the at least one further charged species are metal cations. The first charged species and the at least one further charged species may for instance be transition metal cations.

Separation of precious metals is of particular interest.

Thus, often, the first charged species is a first noble metal cation and the at least one further charged species comprises one or more metal cations other than the first noble metal cation. The at least one further charged species may for instance comprise one or more further noble metal cations other than the first noble metal cation. The term “noble metal”, as used herein, refers to a metal selected from ruthenium (Ru), rhodium (Rh), palladium (Pd), silver (Ag), osmium (Os), iridium (Ir), platinum (Pt), gold (Au), mercury (Hg), rhenium (Re) and copper (Cu). Often, however, the noble metals are selected from ruthenium (Ru), rhodium (Rh), palladium (Pd), silver (Ag), osmium (Os), iridium (Ir), platinum (Pt) and gold (Au). In this embodiment, the first charged species may for instance be a platinum cation, or a palladium cation. Separation of these metals from electronic plating baths is of particular interest. The solution that is treated may therefore comprise a solution from an electronic plating bath. Alternatively, in this embodiment, the first charged species may be a rhodium, rhenium or iridium cation. Separation of these metals from waste streams during the manufacture of catalysts is of particular interest. Accordingly, the solution that is treated, in these embodiments, may comprise a waste stream from the manufacture of a catalyst.

Typically, the first charged species is a first platinum group metal cation and the at least one further charged species comprises one or more metal cations other than the first platinum group metal cation. The at least one further charged species may for instance comprise one or more further platinum group metal cations other than the first platinum group metal cation. As the skilled person will appreciate, a platinum group metal is a metal selected from ruthenium (Ru), rhodium (Rh), palladium (Pd), osmium (Os), iridium (Ir) and platinum (Pt). The first charged species may for instance be a platinum cation, or a palladium cation. Separation of these metals from electronic plating baths is of particular interest. The solution that is treated may therefore comprise a solution from an electronic plating bath. Separation of platinum group metals from waste streams during the manufacture of catalysts is also of particular interest. Accordingly, the solution that is treated, in these embodiments, may comprise a waste stream from the manufacture of a catalyst.

Separation of iron from copper, and of copper from iron, is also of particular interest, for instance, where the solution is a mixed copper/iron aqueous waste stream, for instance a waste stream in the mining industry or the mineral processing industry.

Selective recovery of the copper is of primary interest. Accordingly, in some embodiments the first charged species is a copper cation and the at least one further charged species comprises an iron cation. The copper cation is often Cu²⁺. The iron cation is typically Fe³⁺, but Fe²⁺ may also be present.

Also of interest is the reverse, i.e. removal of iron from copper, especially where the copper is the prevalent species and the desire is to purify it. Thus, in other embodiments, the first charged species is an iron cation and the at least one further charged species comprises a copper cation. The copper cation is often Cu²⁺. The iron cation is typically Fe³⁺, but Fe²⁺ may also be present.

Recovery of scandium from rare earth processing is also of interest. Accordingly, in some embodiments the first charged species comprises scandium. The at least one further charged species typically comprises a rare earth metal cation. The solution that is treated, in this embodiments, may comprise a solution from a rare earth processing stream.

Recovery of metals, for example heavy metals, during the soil washing of contaminated land is also of interest.

The first charged species and the at least one further charged species may for instance be different cations selected from a group I cation, a group II cation, a transition metal cation, a group III cation, a group IV cation, a group V cation, a group VI cation, a group VII cation, a lanthanide cation and an actinide cation. The first charged species and the at least one further charged species may for instance be different cations selected from selected from a group II cation, a transition metal cation, a group IV cation, a group V cation and a group VI cation. The first charged species and the at least one further charged species may for instance be different cations selected from cadmium (Cd), chromium (Cr), copper (Cu), iron (Fe), nickel (Ni), arsenic (As), lead (Pb), mercury (Hg), selenium (Se), silver (Ag), zinc (Zn) and rhodium (Rh). The first charged species and the at least one further charged species may for instance be different cations selected from rhodium, cadmium, chromium, magnesium or zinc, for instance chromium, magnesium or zinc.

Often, however, the first charged species is a copper cation and the at least one further charged species comprises an iron cation. Alternatively, however, the first charged species may be an iron cation and the at least one further charged species may comprise a copper cation.

Preferably, the first charged species is a copper cation and the at least one further charged species comprises an iron cation

For instance, the first charged species may be Cu²⁺ and the at least one further charged species may comprise Fe³⁺.

As the skilled person will appreciate, the relative amounts of the charged species, the polymer and the surfactant in the solution may depend upon the solution being treated in the first place, on the first and further charged species therein, and on the optimum amounts of polymer and surfactant for that particular system.

However, one advantage of the present invention is that it can be used to separate relatively low concentrations of the first charged species from solution. The solution may, for instance, comprise less than or equal to 1,000 ppm of the first charged species, for instance, less than or equal to 500 ppm of the first charged species. Usually, the solution comprises less than or equal to 250 ppm of the first charged species, for instance, less than or equal to 100 ppm of the first charged species. The solution may for instance comprises less than or equal to 50 ppm of the first charged species, for instance, less than or equal to 10 ppm of the first charged species. The solution may, in some embodiments, comprise less than or equal to 5 ppm of the first charged species, for instance about 1 or 2 ppm of the first charged species.

The process of the invention is advantageously able to selectively remove and recover a particular first charged species whose concentration is low compared to the concentration of the at least one further charged species in the solution. Thus, the concentration of the at least one further charged species in the solution may be at least twice the concentration of the first species in the solution. For instance, it may be at least 5 times the concentration of the first species in the solution, or for example at least 10 times the concentration of the first species in the solution. The concentration of the at least one further charged species in the solution may for instance be at least 100 times the concentration of the first species in the solution, for example at least 1000 times the concentration of the first species in the solution.

The concentration of the first species in the solution is typically less than or equal to 100 ppm. This is often the case for instance when first charged species is Cu²⁺.

The concentration of the at least one further charged species in the solution is often less than or equal to 1,000 ppm. This is often the case for instance when first charged species is Cu²⁺ and the at least one further charged species comprises an iron cation.

The ratio of the monomeric molar concentration of the functionalised polymer to the molar concentration of the surfactant in the solution may be vary from case to case and may be any suitable ratio. Often however, the ratio of the monomeric molar concentration of the functionalised polymer to the molar concentration of the surfactant in the solution is from 1:4 to 4:1. It is typically for instance from 2:3 to 3:2. This is often the case for instance when first charged species is Cu²⁺ and the at least one further charged species comprises an iron cation.

The monomeric molar concentration of the polymer in the solution may be vary from case to case and may be any suitable concentration. Often however, the monomeric molar concentration of the polymer in the solution is at least 1 mM. It may for instance be from 1 mM to 10 mM, for example from 3 mM to 7 mM. It may be about 5 mM. This is often the case for instance when first charged species is Cu²⁺, and the functionalised polymer is a cationic, nitrogen-containing polymer (as further defined hereinbefore) such as PEI or PAA.

The concentration of the functionalised polymer in the solution in ppm may vary from embodiment to embodiment, but it may for instance be at least twice the concentration of the first charged species in the solution. It could for instance be at least five times the concentration of the first charged species in the solution.

For instance, the concentration of the functionalised polymer in the solution may be at least 200 ppm, optionally at least 500 ppm, for instance from 200 ppm to 2,000 ppm, or from 500 ppm to 1,000 ppm. This is often the case for instance when first charged species is Cu²⁺, and the functionalised polymer is a cationic, nitrogen-containing polymer (as further defined hereinbefore) such as PEI or PAA.

The molar concentration of the surfactant in the solution may also very from embodiment to embodiment, but it may for example be at least 1 mM, for instance from 2 mM to 9 mM, or from 3 mM to 6 mM. The molar concentration of the surfactant in the solution may for instance be from 4 mM to 5 mM.

As discussed previously the solvent often comprises water. Thus, the solution is typically an aqueous solution.

A particular advantage of the present invention is that it is able to remove a desired first charged species, from particularly acidic solutions. The kinds of effluent being treated here are, for example, acidic mine wastewaters where the pH can drop to zero. The first charged species in this case is often a copper cation or an iron cation, and is typically a copper cation. Most available technology, however, struggles to remove copper from such acidic environments.

Thus, in some embodiments of the process of the invention, the solution treated with the functionalised polymer and the surfactant has a pH of less than or equal to 3. It often, for instance, has a pH of less than or equal to 2.5, for instance a pH of less than or equal to 2. It may for instance have a pH of from 0 to 3, for instance a pH of from 0 to 2.5, a pH of from 0.5 to 2.5.

When the first charged species and the at least one further charged species are negatively charged species, they can in principle be any combination of negatively charged species in which one of the negatively charged species is one that is desired to be removed and recovered from the other negatively charged species, selectively, by the process of the invention.

To give some non-limiting examples, the first charged species and the at least one further charged species may for instance be negatively charged species selected from metal anions, complex anions which comprise a metal, and negatively charged insecticides, pesticides, herbicides, dyes and fertilizers. The first charged species and the at least one further charged species may for example be different negatively charged species including (a) a metal anions; and (b) complex anions which comprise a metal or metalloid.

Examples of negatively charged species comprising a complex anion which comprises a metal or metalloid include oxyanions such as coboltate, cuprate, ferrate, ferrite, ferricyanide, permanganate manganate, nickelate, argenate, vanadata, aluminate, urinate, zincate stannate, chromate and dichromate. The first charged species and/or the at least one further charged species may therefore be selected from any of the aforementioned negatively charged species. For instance, the first charged species and/or the at least one further charged species may be selected from negatively charged species comprising a complex anion which comprises a metal, and in particular from [CrO₄]²⁻, [Cr₂O₇]²⁻, [Fe(CN)₆]³⁻ or [MnO₄]⁻, for instance, [CrO₄]²⁻, [Fe(CN)₆]³⁻ or [MnO₄]⁻. The first charged species and/or the at least one further charged species may be selected from [Cr₂O₇]²⁻, [Fe(CN)₆]³⁻ and [MnO₄]⁻, for instance from [Fe(CN)₆]³⁻ and [MnO₄]⁻.

The first charged species and/or the at least one further charged species may comprise a complex anion which comprises a metal, which metal is a group I metal, a group II metal, a transition metal, a group III metal, a group IV metal, a group V metal, a group VI metal, a group VII metal, a lanthanide metal or an actinide metal.

The first charged species and/or the at least one further charged species may comprise a complex anion which comprises a metal, which metal is a group II metal, a transition metal, a group III metal, a group IV metal, a group V metal, or a group VI metal.

The first charged species and/or the at least one further charged species may comprise a complex anion which comprises a metal, which metal is a group II metal, a transition metal, a group IV metal, a group V metal or a group VI metal, or a combination of two or more thereof

The first charged species and/or the at least one further charged species may comprise a negatively charged species comprising a complex anion which comprises a metal or metalloid, wherein the metal or metalloid may for instance be selected from cadmium (Cd), chromium (Cr), copper (Cu), nickel (Ni), arsenic (As), lead (Pb), mercury (Hg), selenium (Se), silver (Ag) or zinc (Zn).

The first charged species and/or the at least one further charged species may comprise a negatively charged species which is a complex anion which comprises a metal or metalloid, which metal or metalloid is cadmium, chromium, copper, magnesium, nickel, arsenic, lead, mercury, selenium, silver or zinc.

Often, (i) the first charged species and the at least one further charged species are negatively charged species, optionally metal-containing anions; and, preferably, (ii) the surfactant is a cationic surfactant. The functionalised polymer in these case is preferably a polymer which is negatively charged when in aqueous solution.

In the process of the invention, treating the solution with the functionalised polymer and the surfactant results in the first charged species binding to groups of the functionalised polymer that bind preferentially to the first charged species. This facilitates selective removal of the first charged species from the solution.

Usually, in the process of the invention, treating the solution with the functionalised polymer and the surfactant results in the formation of a polymer-surfactant aggregate (PSA) which comprises the functionalised polymer and the surfactant.

The term “polymer surfactant aggregate”, as used herein, which is often abbreviated to “PSA”, refers to an aggregate of a polymer and a surfactant. In particular, it is a species in which surfactant molecules are bound to the polymer. Generally, in a PSA, multiple molecules of the surfactant are bound to any one molecule of the polymer. A PSA may contain more than one molecule of the polymer, but each molecule of the polymer in the PSA is itself bound to multiple surfactant molecules. Generally, the surfactant molecules that are bound to the polymer form micelle-type structures, and the surface of each micelle-like structure binds to the polymer. A micelle-like structure is an aggregate of surfactant molecules. Typically, hydrophilic groups of the surfactant molecules form the surface of each micelle-like structure and hydrophobic groups of the surfactant molecules form the centre of each micelle-like structure. The polymer is typically a hydrophilic polymer. Typically, the hydrophilic surface of each micelle-like structure binds to the hydrophilic polymer, and typically there will be many micelle-like structures bound to one molecule of polymer.

The structure of a PSA can therefore be thought of as resembling a necklace, where a polymer molecule is the chain of the necklace and the surfactant “micelles” are beads attached to the chain. Recent research suggests that linear polymers give rise to polymer surfactant aggregates which have a “necklace” structure of the kind described above, and of the nature described in papers by Shen, Hankins et al. (see Shen, L. C., Nguyen, X. T., & Hankins, N. P. (2015) “Removal of heavy metal ions from dilute aqueous solutions by polymer—surfactant aggregates: A novel effluent treatment process”, Separation and Purification Technology, 152, 101-107; Shen, L. C., Lo, A., Nguyen, X. T., & Hankins, N. P. (2016) “Recovery of heavy metal ions and recycle of removal agent in the polymer— surfactant aggregate process”, Separation and Purification Technology, 159, 169-176; Shen, L. C., Hankins, N. P., & Singh, R. (2016) “Surfactant and Polymer-Based Technologies for Water Treatment”, Emerging Membrane Technology for Sustainable Water Treatment, 249; L. C. Shen, J. Wu, S. Singh, and N. P. Hankins (2017) “Removal of Metallic Anions from Dilute Aqueous Solutions by Polymer—Surfactant Aggregates”, Desalination, 406, 109-118; and L. C. Shen, N. P. Hankins (2017) “Metallic Anion Recovery from Aqueous Streams and Removal Agent Recycle in the Polymer-Surfactant Aggregate Process”, Desalination, 406, 67-73).

However, if a branched polymer is employed instead of a linear polymer, the PSA has a “plum-pudding” structure rather than a necklace structure. In a plum-pudding structure, the branched polymer forms the bulk of the “plum pudding” and the surfactant “micelles” (which are attached to the branched polymer) form the “plums” distributed throughout the bulk. Thus, a plum-pudding structure is more spherical overall, and the surfactant “micelles” are distributed more homogeneously.

An advantage of employing a branched polymer and, therefore, of forming a PSA with a plum pudding structure, is that the PSA tends to flocculate more rapidly upon contact with a charged species and to settle out more rapidly.

Thus, in the process of the invention, treating the solution with the functionalised polymer and the surfactant typically results in the formation of a polymer-surfactant aggregate (PSA), as defined above, which comprises the functionalised polymer and the surfactant.

Typically, the PSA which forms then binds preferentially to the first charged species. Self-flocculation then typically occurs, such that the flocs loaded with the first charged species will settle out or can be easily filtered from the treated solution. Then, as will be explained in further detail below, the first charged species in the separated flocs can be recovered either by pH adjustment and concentration into metal salts, or the flocs can be incinerated and the metallic ions recovered as concentrated metal oxides.

Thus, in the process of the invention, a polymer-surfactant aggregate as defined above may be formed, such that the first charged species may bind to groups of the functionalised polymer in the PSA that bind preferentially to the first charged species. This results in the formation of a modified polymer-surfactant aggregate (modified PSA), wherein the modified PSA comprises: (i) a PSA as defined above which comprises the functionalised polymer and the surfactant, and (ii) the first charged species, wherein the first charged species is bound to groups of the functionalised polymer in the PSA that bind preferentially to the first charged species.

In the process of the invention, therefore, the step of treating the solution with the functionalised polymer and the surfactant results in the formation of a modified polymer-surfactant aggregate (modified PSA) which comprises: (i) a polymer-surfactant aggregate (PSA) which comprises the functionalised polymer and the surfactant, and (ii) the first charged species, wherein the first charged species bound to groups of the functionalised polymer in the PSA that bind preferentially to the first charged species.

The modified PSA, which comprises the functionalised polymer, the surfactant and the first charged species, is usually self-flocculating.

The interaction, in the modified PSA, between (a) a group of the functionalised polymer in the PSA that binds preferentially to the first charged species (a functional group) and (b) the first charged species itself, may be any suitable interaction. It is often a chelation, but it may alternatively for instance involve ion-pair formation between (a) and (b), electrostatic bonding between (a) and (b), or any other kind of non-covalent or covalent bonding between (a) and (b).

The process of the invention typically further comprises separating from the solution a composition comprising the functionalised polymer, the surfactant and the first charged species, wherein the first charged species is bound to said groups of the functionalised polymer that bind preferentially to the first charged species.

Indeed, the invention provides a process for selectively removing a first charged species from a plurality of charged species in solution, wherein the solution comprises a plurality of charged species dissolved in a solvent, wherein the plurality of charged species comprises the first charged species and at least one further charged species which is different from the first charged species, which process comprises separating from the solution a composition comprising: a functionalised polymer, a surfactant and the first charged species, wherein the functionalised polymer comprises groups that bind preferentially to the first charged species and the first charged species is bound to said groups.

Usually, said composition comprising the functionalised polymer, the surfactant and the first charged species, comprises a modified PSA as defined above, which comprises: (i) a polymer-surfactant aggregate (PSA) which comprises the functionalised polymer and the surfactant, and (ii) the first charged species, which is bound to groups of the functionalised polymer in the PSA that bind preferentially to the first charged species.

Generally, separating the composition from the solution comprises self-flocculation of the modified PSA.

Additionally or alternatively, separating the composition from the solution may comprise separation by: a separation method based on real or artificial gravity, centrifugation, adsorption, decantation, elutriation, filtration, magnetic separation, sedimentation or sieving, or a combination thereof.

As used herein, adsorption is the adhesion of particles (e.g. particles in the composition, the complex, the charged species, the polymer comprising ionisable groups or the ionic surfactant) in solution to a surface.

As used herein, decantation is a process for the separation of mixtures, for example, by removing liquid layer.

As used herein, elutriation is a process for separating particles based on their size, shape and/or density. The processes typically uses a stream of gas or liquid flowing in a direction usually opposite to the direction of sedimentation.

As used herein, filtration is a process of separating solids from liquid using a medium that allows liquids to pass through it, but prevents solids of a certain size from passing through it.

As used herein, magnetic separation is a process of using a magnetic force to remove a magnetically susceptible material.

As used herein, sedimentation refers to the tendency for particles in suspension to settle out of a liquid.

As used herein, sieving is a process for separating solids from liquids using a sieve, i.e. a mesh or net capable of effectively trapping solid particles.

Typically, the step of separating the composition from the solution comprises filtration and/or sedimentation, for instance, the step of separating the composition from the solution may comprise passing the solution through a filter.

As the skilled person will understand, where treatment speed is important, a coarse filtration membrane, or indeed self-flocculation, offers higher flux than ultrafiltration and nanofiltration membranes with the same membrane area.

The step of separating the composition from the solution may comprise passing the solution through a filter, wherein the pore size of the filter is smaller than the size of said complex. The pore size may, for instance, be larger than the size of the charged species. Thus, typically, the complex will not be able to pass through the filter whereas any charged species that are not part of a complex will be able to pass through the filter.

As used herein, the pore size is the average diameter of the pore. If, for example, the pore is not spherical, the diameter of an individual pore is the diameter of a circle having the same area as the pore.

The step of separating the composition from the solution may comprise passing the solution through a filter, wherein the filter has an average pore size of from 5 μm to 75 μm, for instance, from 5 μm to 50 μm. Usually, the filter has an average pore size of from 15 μm to 25 μm, for instance, about 20 μm.

Usually, the process further comprises removing the first charged species from the composition comprising the functionalised polymer, the surfactant and the first charged species. Typically, in the process of the invention, removing the first charged species from the composition comprises forming a dissolved salt of the first charged species.

Typically, the composition comprises a modified PSA comprising: (i) a polymer-surfactant aggregate (PSA) which comprises the functionalised polymer and the surfactant, and (ii) the first charged species, which is bound to groups of the functionalised polymer in the PSA that bind preferentially to the first charged species. Thus, typically, the process of removing the first charged species from said composition comprises removing the first charged species from the modified PSA.

Indeed, the invention also provides a process for removing a first charged species from a modified polymer-surfactant aggregate (modified PSA) which comprises: (i) a polymer-surfactant aggregate (PSA) which comprises a functionalised polymer and a surfactant, and (ii) a first charged species, wherein the functionalised polymer comprises groups that bind preferentially to the first charged species and the first charged species is bound to said groups, wherein the process comprises: removing the first charged species from the modified PSA. Removing the first charged species from the modified PSA typically comprises forming a dissolved salt of the first charged species.

As mentioned above, typically, in the process of the invention, removing the first charged species from the composition comprises forming a dissolved salt of the first charged species.

As the skilled person will appreciate, a salt is an ionic compound that may be formed when a positively charged species reacts with a negatively charged species to form an electrically neutral product. Typically, a salt is produced by the neutralization reaction between an acid and a base. Thus, the formation of a salt may require the pH of a solution to be adjusted (i.e. increased or decreased) to produce the desired result. Further, for the first charged species to form a neutral species, the salt formation typically requires the presence of a suitable counter ion, e.g. when the first charged species is a positively charged species the counter ion will be a negatively charged counter ion and when the first charged species is a negatively charged species the counter ion will be a positively charged counter ion. The counter ion may be found in the solution or may be added to the solution as part of the process of salt formation.

Thus, usually, forming a dissolved salt of the first charged species comprises adjusting the pH.

Typically, the first charged species (and the at least one further charged species) is a positively charged species and adjusting the pH comprises treating the composition with an acidic solution. Thus, adjusting the pH often comprises reducing the pH.

The acid may for instance be selected from an inorganic acid, a sulfonic acid, a carboxylic acid and a halogenated carboxylic acid, or a combination thereof.

Examples of inorganic acids include, but are not limited to, hydrofluoric acid, hydrochloric acid, hydrobromic acid, hydroiodic acid, hypochlorous acid, chlorous acid, chloric acid, perchloric acid, sulfuric acid, fluorosulfuric acid, nitric acid, phosphoric acid, fluoroantimonic acid, fluoroboric acid, hexafluorophosphoric acid, chromic acid and boric acid.

Examples of sulfonic acids include, but are not limited to, methanesulfonic acid, ethanesulfonic acid, benzenesulfonic acid, p-toluenesulfonic acid, trifluoromethanesulfonic acid and polystyrene sulfonic acid.

Examples of carboxylic acids include, but are not limited to, acetic acid, citric acid, formic acid, gluconic acid, lactic acid, oxalic acid and tartaric acid.

Examples of halogenated carboxylic acid include, but are not limited to, fluoroacetic acid, trifluoroacetic acid, chloroacetic acid, dichloroacetic acid and trichloroacetic acid.

The acid may, for instance, comprise an inorganic acid such as sulphuric acid (H₂SO₄). The sulphuric acid may, for instance, be a solution of sulphuric acid having a pH of approximately 1.

Typically, in the process of the invention, adjusting the pH comprises reducing the pH to a pH of less than or equal to 1.5. The experiments described herein for instance describe a a pH of 1 needed for recovering Cu from mono-picolyl-PAA.

Adjusting the pH may for instance comprise reducing the pH to a pH of less than or equal to 0. Such a pH may for instance be needed for recovering Cu from bis-picolyl-PAA

Alternatively, in the third process of the invention, the pH may be adjusted to a pH of less than or equal to 7, for instance the pH is adjusted to a pH of less than or equal to 6. The pH may, for instance, be adjusted to a pH of less than or equal to 5. As the skilled person will appreciate, the adjusted pH depends upon the charged species present.

Alternatively, in the process of the invention, removing the first charged species from the composition may comprise treating the composition with an amine solution.

In other embodiments, the first charged species (and the at least one further charged species) are negatively charged species and adjusting the pH comprises treating the composition with an alkaline solution. Thus, the process of the invention may comprise treating the composition with a base. Suitable bases include hydroxides such as sodium hydroxide (NaOH), potassium hydroxide (KOH), ammonium hydroxide (NH₄OH), calcium hydroxide (Ca(OH)₂), magnesium hydroxide (Mg(OH)₂), barium hydroxide (Ba(OH)₂), aluminium hydroxide (Al(OH)₃), iron (ii) hydroxide (Fe(OH)₂), iron (iii) hydroxide (Fe(OH)₃), zinc hydroxide (Zn(OH)₂) and lithium hydroxide (LiOH). The base may, for example, be sodium hydroxide or potassium hydroxide, for instance, potassium hydroxide.

Typically, the process further comprises separating the dissolved salt of the first charged species from the functionalised polymer and the surfactant.

The step of separating the dissolved salt from the functionalised polymer and the surfactant may comprise a process of separation selected from adsorption, decantation, elutriation, filtration, magnetic separation, sedimentation and sieving, or a combination thereof The process of separation may, for instance, be filtration or sedimentation, or a combination thereof.

Usually, a concentrated soluble salt is formed, followed by filtration/settling to separate this from the remaining polymer-surfactant solid. Thus, preferably, separating the dissolved salt from the functionalised polymer and the surfactant comprises filtration, optionally wherein separating the salt from the functionalised polymer and the surfactant comprises filtering a composition comprising (i) a solution of the salt, and (ii) a precipitate comprising the functionalised polymer and the surfactant.

Filtering the composition may for example comprise using a filter having an average pore size of from 5 μm to 75 μm, for instance, from 5 μm to 50 μm. Usually, the filter has an average pore size of from 15 μm to 25 μm, for instance, about 20 μm.

Removing the first charged species from the composition may comprise heating the composition and recovery of the first charged species in the form of an oxide comprising the first charged species. Typically, heating the composition comprises incineration of the composition. Typically, the heating also causes sublimation of the resulting metal oxide. The first charged species is typically then recovered in the form of a solid oxide comprising the first charged species.

After the step of removing the first charged species from the composition, the process of the invention may further comprise recovering the functionalised polymer and/or the surfactant.

Typically, recovering the functionalised polymer and/or the surfactant comprises adjusting the pH of a composition comprising the functionalised polymer and the surfactant.

In some embodiments, the first charged species and the at least one further charged species are positively charged species, and the step of recovering the functionalised polymer and/or the surfactant comprises treating the composition comprising the functionalised polymer and the surfactant with a base or an alkaline solution. Thus, the step of recovering the functionalised polymer and/or the surfactant comprises increasing the pH. Suitable bases for increasing the pH of the solution include hydroxides such as sodium hydroxide (NaOH), potassium hydroxide (KOH), ammonium hydroxide (NH₄OH), calcium hydroxide (Ca(OH)₂), magnesium hydroxide (Mg(OH)₂), barium hydroxide (Ba(OH)₂), aluminium hydroxide (Al(OH)₃), iron (ii) hydroxide (Fe(OH)₂), iron (iii) hydroxide (Fe(OH)₃), zinc hydroxide (Zn(OH)₂) and lithium hydroxide (LiOH). The base may, for example, be sodium hydroxide or potassium hydroxide, for instance, potassium hydroxide.

An acid may be used at this stage in the exceptional case where the polymer is hydrophobic and remains insoluble in basic solution. Thus, recovering the functionalised polymer and/or the surfactant may comprise adjusting the pH of a composition comprising the functionalised polymer and the surfactant to a pH of less than 1, optionally a pH of less than 0, or less than −1; and/or adjusting the pH to a pH lower than the pH employed to form a salt of the first charged species.

In the cases where the use of an acid is needed for the polymer and surfactant recovery, the use of weak acid surfactants of relatively high pKa is preferable since the surfactant (rather than the polymer) is being neutralised.

In some embodiments, the first charged species and the at least one further charged species are negatively charged species, and the step of recovering the functionalised polymer and/or the surfactant comprises treating the composition comprising the functionalised polymer and the surfactant with an acid, for instance with an acidic solution. The step of recovering the polymer and/or the surfactant may, therefore, comprise decreasing the pH of the solution.

The acid may comprise an inorganic acid (for instance sulfuric acid), a sulfonic acid, a carboxylic acid or a halogenated carboxylic acid. The acidic solution may be an acid selected from an inorganic acid, a sulfonic acid, a carboxylic acid and a halogenated carboxylic acid, or a combination thereof. The inorganic acid may, for instance, be an inorganic acid as defined herein. The sulfonic acid may, for instance, be a sulfonic acid as defined herein. The carboxylic acid may, for instance, be a carboxylic acid as defined herein. The halogenated carboxylic acid may, for instance, be a halogenated carboxylic acid as defined herein.

In the cases where the use of an acid is needed for the polymer and surfactant recovery, the use of weak acid surfactants of relatively high pKa is preferable since the surfactant (rather than the polymer) is being neutralised.

After the step of recovering the functionalised polymer and/or the surfactant, the recovered functionalised polymer and/or the recovered surfactant may, for instance, be used in another process, i.e. the recovered functionalised polymer and/or the recovered surfactant may be recycled. In one embodiment, the process of the invention comprises re-using the recovered functionalised polymer and/or the recovered surfactant in a further cycle of the process of the invention for selectively removing a charged species from a solution. The further cycle of the process may be a process as further defined anywhere herein.

The invention further provides the use of a functionalised polymer and a surfactant to selectively remove a first charged species from a solution comprising a plurality of charged species dissolved in a solvent, wherein the plurality of charged species comprises the first charged species and at least one further charge species which is different from the first charged species, and the functionalised polymer comprises groups that bind preferentially to the first species.

In the use of the invention, the functionalised polymer may be a functionalised polymer as further defined anywhere herein. The surfactant may be a surfactant as further defined anywhere herein. The first charged species, the at least one further charged species, the solution and the solvent may also be as further defined anywhere herein. The groups that bind preferentially to the first species may also be as further defined anywhere herein.

The invention further provides the use of a polymer-surfactant aggregate (PSA) to selectively remove a first charged species from a solution comprising a plurality of charged species dissolved in a solvent, wherein the polymer-surfactant aggregate comprises a functionalised polymer and a surfactant, the plurality of charged species comprises the first charged species and at least one further charge species which is different from the first charged species, and the functionalised polymer comprises groups that bind preferentially to the first species.

In the use of the invention, the functionalised polymer may be a functionalised polymer as further defined anywhere herein. The surfactant may be a surfactant as further defined anywhere herein. The first charged species, the at least one further charged species, the solution and the solvent may also be as further defined anywhere herein. The groups that bind preferentially to the first species may also be as further defined anywhere herein. The polymer-surfactant aggregate, and/or the groups that bind preferentially to the first species, may also be as further defined anywhere herein.

The invention further provides a modified polymer-surfactant aggregate (modified PSA), which comprises:

(i) a polymer-surfactant aggregate (PSA), comprising a functionalised polymer and a surfactant; and

(ii) a first charged species,

wherein the functionalised polymer comprises groups that bind preferentially to the first charged species and the first charged species is bound to the groups.

In the modified PSA, the polymer-surfactant aggregate (i) may be a polymer-surfactant aggregate as further defined herein.

The groups that bind preferentially to the first species, may also be as further defined anywhere herein, for instance they may comprise chelating groups, for instance bidentate or tridentate chelating groups. These bidentate or tridentate chelating groups may be as further defined herein. Often, for instance, the chelating groups comprise mono-2-picolyl amine groups or bis-2-picolyl amine groups. The functionalised polymer may also be as defined anywhere herein.

The surfactant in the modified PSA is typically an ionic surfactant. It may for instance be an anionic surfactant, which may be as defined further herein, for example sodium dodecyl sulfate (SDS).

The first charged species may also be as defined anywhere herein. The first charged species may for instance be a metallic ion. The first charged species may for instance be a positively charged species, for instance a metallic cation. The first charged species may be a metal cation. It may for instance be a noble metal cation or a platinum group metal cation. The first charged species may be, for instance, a copper cation, e.g. Cu²⁺. Alternatively, it may be an iron cation, for instance Fe³⁺.

The invention also provides a polymer-surfactant aggregate (PSA), comprising: (i) a functionalised polymer which comprises groups that are capable of binding preferentially to a first charged species, and (ii) a surfactant.

The polymer-surfactant aggregate of the invention may be a polymer-surfactant aggregate as further defined herein.

The groups that bind preferentially to the first species, may also be as further defined anywhere herein, for instance they may comprise chelating groups, for instance bidentate or tridentate chelating groups. These bidentate or tridentate chelating groups may be as further defined herein. Often, for instance, the chelating groups comprise mono-2-picolyl amine groups or bis-2-picolyl amine groups. The functionalised polymer may also be as defined anywhere herein.

The surfactant in the modified PSA is typically an ionic surfactant. It may for instance be an anionic surfactant, which may be as defined further herein, for example sodium dodecyl sulfate (SDS).

The invention will be further described in the following Examples.

### EXAMPLES

### Introduction

The process of the invention is a novel industrial process for the selective recovery and concentration of dilute but valuable ionic species (typically metallic ion species) from aqueous streams (including effluents). It uses functionalized polymers. It often for instance employs functionalized cationic polymers, such as functionalized polyethylenimine (PEI) or functionalized polydiallyldimethylammonium chloride (PDADMAC), and an anionic surfactant, such as sodium dodecyl sulfate (SDS), to form self-removable species. The polymer will effectively adsorb dilute ions—typically metal ions—from the effluent. In the presence of the surfactant, a self-flocculating system is finally created.

Typically, after a critical point in the adsorption and in the presence of surfactant of opposite charge to the target ionic species, a self-flocculation occurs due to electrical charge neutralisation, such that the metal-loaded flocs will settle out or can be easily filtered from the treated aqueous stream. Finally, the target metallic ions in the separated flocs are usually recovered either by acidification and concentration into metal salts, or the flocs can be incinerated and the metallic ions recovered as concentrated metal oxides.

The process is typically used to recover metallic ions from dilute industrial effluent and process streams. It can be used in a wide variety of industries, for the selective removal, recovery and concentration of metallic ions from dilute aqueous process streams. Examples of this include (but are by no means limited to); the selective recovery of one or more platinum group metals such as platinum and/or palladium from, for instance, electronic plating baths; the selective recovery of one or more precious metals, such as rhodium, rhenium and iridium, from waste streams during, for instance, the manufacture of catalysts; the selective recovery of copper from, for instance, mixed copper/iron aqueous waste streams, e.g. waste streams in the mining and mineral processing industries; the recovery of heavy metals during the soil washing of contaminated land; and scandium recovery from rare earth processing.

It makes use of functionalized polymers as a backbone structure that selectively adsorbs and removes metallic ions from solution, such as precious and heavy metals. Typically, oppositely charged surfactants form highly compact and charged adsorptive aggregates with the polymer elsewhere on the polymer backbone (to form a polymer-surfactant aggregate, or PSA); upon a critical metal adsorption, the whole system becomes electrically neutral and self-flocculates into large, solid phase macro-particles which are easily settled or filtered out. A mild downward swing in pH can then be used to recover the target metal ions as a concentrated salt, and with a mild upward swing in pH the polymer-surfactant substrate may be recycled back into the process. Alternatively, the flocculated macro-particles are incinerated, and metal ions are recovered as concentrated metal oxide solids.

The polymer surfactant aggregate (PSA) materials employed in the present invention can potentially increase the treatment speed by orders of magnitude compared with conventional ion exchange resins. In the process of the invention, the PSA process typically starts in a homogeneous, colloidally-dispersed phase and finishes in separated liquid and solid phases. In the process of the invention, the modified (functionalized) polymer (of the kind which could also be used to coat an ion-exchange resin surface) is dispersed directly into the effluent along with surfactant to form a colloidal phase. Typically, at the same time as the targeted ions are bonded to the polymer chains, the PSA self-flocculates in-situ under charge neutralisation and hydrophobic attraction, and these flocs then grow as a solid phase and settle down under gravity (or can be removed by filtration). Importantly, the separated ions can be recovered from the solid phase in the form of a concentrated salt by a simple pH shifting operation, and the polymer-surfactant mixed liquid can be recycled following pH readjustment into the next batch of operation.

The process is simple to operate, consumes low energy, and the initial process material inventory is inexpensive and can be recycled with zero material loss or discharge. Current competing technologies for selectively targeting metallic effluent streams are either capitally expensive (membranes), complex (fixed-bed ion exchange), or consume excessive energy and material resources (adsorption, and precipitation). They also offer limited scope for sustainability and recyclability. Many effluent streams are dilute, but most existing technology then becomes less effective. The process of the invention is superior in all these aspects, and has the additional advantage that standard water flocculation equipment can be adapted for its large-scale application.

Typically, in the process of the invention, the surfactant and functionalized polymer are able to form polymer-surfactant species, also known as a polymer-surfactant aggregate (PSA), and generally at low substrate concentration for either component (0.1mM level). This PSA species has three main technical advantages: the high adsorbent surface area of the species, the self-flocculation (and subsequent separation) ability of the polymer-surfactant aggregate in the presence of adsorbed target metal ions, and the selective removal and subsequent concentrative recovery of metal ions using the same aggregate.

The high surface area may be achieved by the polymer-surfactant species being nanomolecular in size, which allows them to function at dilute metal ion concentrations via specific molecular interactions between cationic or anionic metal ions and functional groups on the polymers.

These metal-adsorbed species (also referred to herein as “modified polymer-surfactant aggregates”) are eventually self-flocculating at a critical point, due to charge neutralisation and the presence of strong hydrophobic attraction forces, and can form larger, self-settling or easily filterable floc particles, due to the intermolecular associations between the components of the species. Specifically, there may be attractive ‘polymer bridging’ forces resulting from opposing charges on different polymer chains, as well as the hydrophobic interactions between polymer hydrocarbon chains. For instance, a metal cation adsorbed onto one polymer chain may be linked by attractive forces to a surfactant anion residing on another chain, to form a polymer bridge between the two chains. The flocculation only occurs once the metal adsorption onto the polymer chain has reached a critical point; the target metal that causes the flocculation can be controlled by the addition of the correct functional groups to the polymer chain. Multivalent metallic ions present in the system can also form polymer bridges between the species and the growing floc particles (these are different from the polymer bridges described above; in this case, the metal ion is effectively chelated by two different polymer chains). This growth leads to a significant increase in their sizes (from nano-meters to micro-meters or milli-metres). A very large proportion of these flocculated particles can thus be settled easily by gravity, while other precipitates can be effectively removed via simple filtration.

A key advantage is the selective removal and recovery of the metallic ions present in the system, which is thought to be caused by the competitive adsorption between metallic ions and the polymer functional groups. If the dosages of polymer and surfactant recovery agent are optimised for the particular amount of target metal in the solution, a relatively high purity and recovery of this concentrated metal ion can be attained. As noted previously, the target metal ion that causes the self- flocculation process can be controlled by the addition of the correct functional group. Thus, the latter functional group enables both a selective removal of the target metal ion from the stream and a self-triggered flocculation into a recoverable, concentrated form.

To summarise the advantages of the process of the invention, it is a very simple, low cost process that can use smart, inexpensive, easily manufactured and recyclable materials, to selectively recover valuable metals from industrial process and effluent streams—it is non-complex and sustainable. The process is simple, and may be based on mixing and settling or filtration, using inexpensive equipment such as tanks, mixers, pumps and pipes. It generally uses substrate materials available in bulk at low cost, such as polymers and surfactants. Most importantly, the polymer is modified via functionalisation to allow a tunable recovery of the target metal ion. The removal agent is usually self-flocculating and is thus easily removed prior to facile recovery of the target species. The removal agent can be recycled, which reduces both cost and environmental impact. The advantages of the process of the invention compared with existing treatment techniques can be listed in six categories:

1: Selectivity to target ion: the polymer functionality can be tuned to target specific ions from complex mixtures.

2: Target ion removal efficiency: when adsorbed and saturated, the removal agent adsorbent will flocculate from solution, which drives the adsorption to high percentages. This process is thus self-driven upon removal of the target species from the stream of interest.

3: Material cost: the adsorbent may be manufactured from inexpensive base materials, and can have a high target ion concentration when saturated.

4: Performance stability: the adsorbent may be continuously removed from solution and is not exposed to process fluids or liquid flow for extended periods. This removes the stability and recyclability issues that plague heterogeneous ion exchange or solvent extraction.

5: Low complexity of process: the process typically uses simple and well-established techniques—flocculation, settling and filtration.

6: Treatment speed: the rate-limiting step is the flocculation; the adsorption of the target ions to the polymer chains occurs in homogeneous solution, which is in principle rapid.

Furthermore, the process of the invention is capable of removing a high percentage (>90%) of the metallic ions contained within dilute (for example 10 mg/L or less) solutions by using only a small amount of polymer and surfactant. Table 1 summarizes the comparative performance of the present invention with currently available technology.

TABLE 1
Comparative performance of the present invention and current methods for
selective recovery of dilute metallic ions from aqueous process streams.

| | Capital | Operational | Complexity | Performance | | Treatment |
|---|---|---|---|---|---|---|
| | cost | cost | of process | stability | Selectivity | speed |
| Ion | High | High | Medium | High | High | Medium |
| exchange | | | | | | |
| Membrane | High | High | Medium | High | High | Medium |
| filtration | | | | | | |
| Biosorption | Medium | Low | High | Medium | Low | Low |
| Adsorption | Medium | Medium | Medium | High | Medium | Low |
| Chemical | Low | High | Low | High | Low | High |
| precipitation | | | | | | |
| Present | Low | Low | Low | High | High | High |
| invention | | | | | | |

Thus, the process of the invention competes favourably with all existing technologies in all the important performance categories.

Although the following Example is focussed on the selective recovery of charged metallic species from aqueous industrial process streams, the process of the invention could also be used to selectively remove and recover the heavy or other multivalent metal ions in soil washing water from metal ion contaminated land. It could also be used to remove other, non-metallic charged species, such as charged organic species in process streams (such as the pesticide 2,4 diphenoxyacetic acid), and charged biological species, such as the dewatering of algal cells in biofuel production.

### Summary of Experimental Work and Results

In this Example of the invention, a polymer surfactant aggregate (PSA) process has been applied to treat industrial effluents. Copper separation and recovery from copper/iron (Cu/Fe) mining effluents has been studied in detail, in particular the selective removal of Cu²⁺ from Fe³⁺ at pH 2. Modified polymers were optimised for SDS dosage and tested for selective Cu²⁺ and Fe³⁺ separation. Also, the modified polymer and surfactant were recycled three times to investigate the performance of the recovery method and to examine the reusability of the PSA removal agent for each subsequent cycle of reuse. Regarding Cu/Fe separation, 95% of 100 ppm Cu²⁺ was selectively removed from 500 ppm Fe³⁺ (hardly removed) at pH 2, using 800 ppm mono 2-picolylamine modified poly(allylamine) and 5 mM sodium dodecyl sulphate. 75% of the Cu²⁺ was recovered using a pH 1 solution; the polymer and surfactant were recovered and recycled using pH 13 solution and reused in several subsequent cycles, with the same potency as fresh material and a self-optimised dosage.

### Materials and Methods

Poly(ethyleneimine) (PEI) (average Mw ˜750,000, 50 wt. % in H₂O) and sodium dodecyl sulphate (SDS) (purity ≥99.0%) were obtained from Sigma Aldrich. 15 wt. % poly(allylamine) (PAA) solution (Mw 15,000) was obtained from Polysciences, Inc. CuSO₄ and Fe₂(SO₄)₃ were provided in house.

### Preparation of Functionalised Polymers

(1) mono 2-picolylamine modified polylallylamine (Modified by pyridine carboxaldehyde)

Polyallylamine solution (25 mmole, 15 wt %) was added to a flask and the water removed under vacuum. Pyridine carboxaldehyde (25 mmole) was dissolved in methanol and added to the polymer; this was stirred for 2 h at room temperature. The solution was cooled to 0° C. under argon and sodium borohydride (26 mmole, 1.01 g) was added. The mixture was allowed to warm to room temperature and stirred overnight. Water (20 mL) was added and stirred for 1 h. The organic was extracted with DCM and dried over magnesium sulfate. The solvent was removed under vacuum to yield viscous yellow oil (93%).

(2) bis 2-picolylamine Modified polylallylamine (Modified by pyridine carboxaldehyde)

Polyallylamine solution (25 mmole, 15 wt %) was added to a flask and the water removed under vacuum. Pyridine carboxaldehyde (50 mmole) was dissolved in methanol and added to the polymer; this was stirred for 2 h at room temperature. The solution was cooled to 0° C. under argon and sodium borohydride (26 mmole, 1.01 g) was added. The mixture was allowed to warm to room temperature and stirred overnight. Water (20 mL) was added and stirred for 1 h. The organic was extracted with DCM and dried over magnesium sulfate. The solvent was removed under vacuum to yield viscous yellow oil (93%).

(3a) Picolyl chloride Modified PAA (at a picolyl-chloride:PAA Molar Ratio of 2)

Picolyl chloride-HCl (50 mmol, 8.20 g) and water (20 mL) were combined and cooled in an ice bath, and neutralized with 10 M NaOH solution (50 mmol, 5 mL). Then 25 mM PAA (15wt % solution, 9.52 g) and DCM (20 mL) were added to the solution. 10 M NaOH solution (50 mmol, 5 mL) is diluted with 15 mL water; this solution is slowly added as the mixture stirred for 48 hours at room temperature, the pH was maintained around pH 9-10. The organic phase was washed with 20% NaOH solution and dried over magnesium sulfate. The solvent was removed under vacuum to yield a dark red solid (5.29 g, 88%).

(3b) Picolyl chloride Modified PAA (at picolyl-chloride:PAA Molar Ratios of 1, 0.5, and 0.2)

Picolyl chloride-HCl (25, 12.5 or 5 mmole, for picolyl-chloride:PAA molar ratios of 1, 0.5, and 0.2 respectively) was weighed to a tube, and one equivalent of NaOH added (as 10 M solution) which formed a biphasic slurry. Then, 25 mmole PAA (as 15wt % solution, 9.52 g) was added to the tube, which gave a pink-red solution of the free base. One equivalent (to picolyl chloride) of NaOH (as 10 M solution) was added to the solution. The mixture was heated and stirred in a water bath at 60° C. overnight, and the samples formed viscous solutions, some containing precipitates. These were acidified with H₂SO₄ and made up to 50 mL to provide a 500 mM 2-picolylamine-poly(allylamine) solition.

(4) picolyl-chloride Modified PEI (at picolyl-chloride:PEI Molar Ratios of 1, 0.5 and 0.2)

Based on the molar concentration ratio of picolyl chloride and PEI (at picolyl-chloride:PEI molar ratios of 1, 0.5 and 0.2), various picolyl chloride-HCl (25, 12.5, and 5 mmole correspondingly) were weighed to a tube, and one equivalent of NaOH was added (as 10 M solution) to the tube, which formed a biphasic slurry. Then 25 mmole PEI (15 wt % solution, 7.17 g) was added to the picolyl-chloride slurry, which gave a pink-red solution. After that, one equivalent of NaOH (10 M solution) was added to the mixed solution. The mixture was heated and stirred in a water bath at 60° C. In a short time, a red precipitate formed and a few drops of 95% H₂SO₄ were added to dissolve the precipitate, which gave a brownish yellow coloured solution. The solution was heated and mixed overnight. The solution was made up to 50 mL to provide a 500 mM picolyl-chloride modified PEI solution.

Treatment of Metal Ion Solutions with Functionalised Polymer and Surfactant

Polymer, surfactant and metal ion solutions were prepared from 4000 ppm polymer, 0.1 M SDS and 0.01 M metal ion stock solutions made in volumetric flasks. The metal ion stock solution was diluted first, and some was retained for determining the initial metal concentration. The polymer stock solution was then added, and the surfactant was finally added to the metal solution. The solution was stirred for 10 to 60 min at 250 rpm before being filtered by a 0.45 μm syringe filter. Samples of both the filtrate and of the initial diluted metal ion solution were sent for ICP-OES analysis to determine the metal concentrations. Regarding pre-treatment of the industrial effluents, they were filtered by a 0.45 μm syringe filter first before following the procedure given above. The pH of the solution was determined before adding any polymer and surfactant, rather than after adding the polymer and surfactant.

The optimum dosage of removal agents was determined by monitoring three main parameters: removal efficiency of the metal ions, the amount of surfactant leakage into the filtrate, and the flocculation and sedimentation speed.

### Results and Discussion

### Copper and Iron Removal

### Example 1: Using the Polymer Polyethylenimine (PEI)

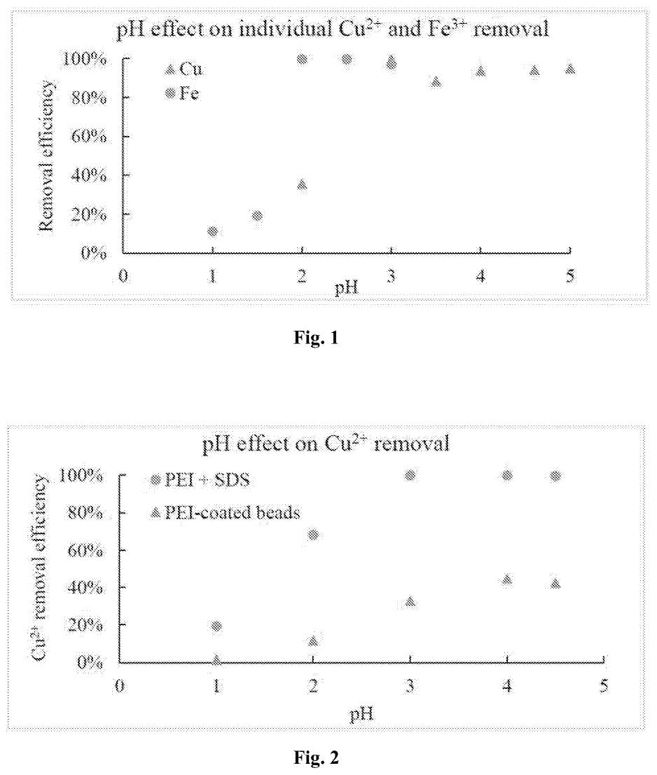

In FIG. 1, the effects of pH on the individual removal of Cu²⁺ and Fe³⁺ from an effluent containing roughly equal concentrations of each are investigated. The PEI polymer is unmodified. The results suggest that PEI can effectively remove Fe³⁺ at pH 2-3 and Cu²⁺ at pH 3-5. For such mixtures, this will be useful for separating Fe³⁺ from Cu²⁺ at lower pH, but at the same pH range it will be unsatisfactory for separating Cu²⁺ from Fe³⁺. The Fe³⁺ will be removed with Cu²⁺ at pH 3, and at pH 2 Fe³⁺ is removed but the Cu ²⁺ remains. In addition, the solubility of Fe³⁺ deceases quickly when the pH is higher than 2.5-3. Thus, it is essential to be able to remove Cu²⁺ at pH 2 or lower in order to separate Cu²⁺ from Fe³⁺.

In FIG. 2, the effect of pH on copper removal is compared for the PSA and the ion-exchange resin. The same Cu²⁺ removal trend with increasing pH is also found for PEI coated silica beads, but the beads have a maximum removal efficiency at pH 3 of 45% compared to 99.8% for the PEI-SDS system at the same polymer dosage. There are two possibilities for the lower removal efficiency of Cu²⁺ for PEI coated silica resins. Firstly, the mass transfer kinetics for the resins is relatively slow, so that 30 minutes of mixing time may be not enough for the Cu ²⁺ to load. Secondly, the 4 g/l silica resin dosage employed might be insufficient, so that the saturation loading capacity of the resin is reached.

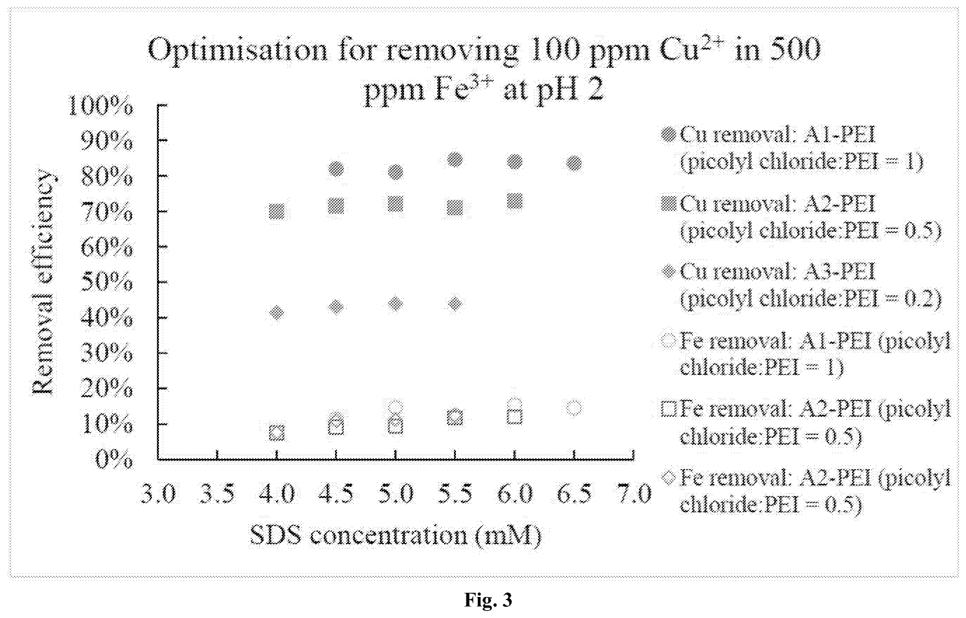

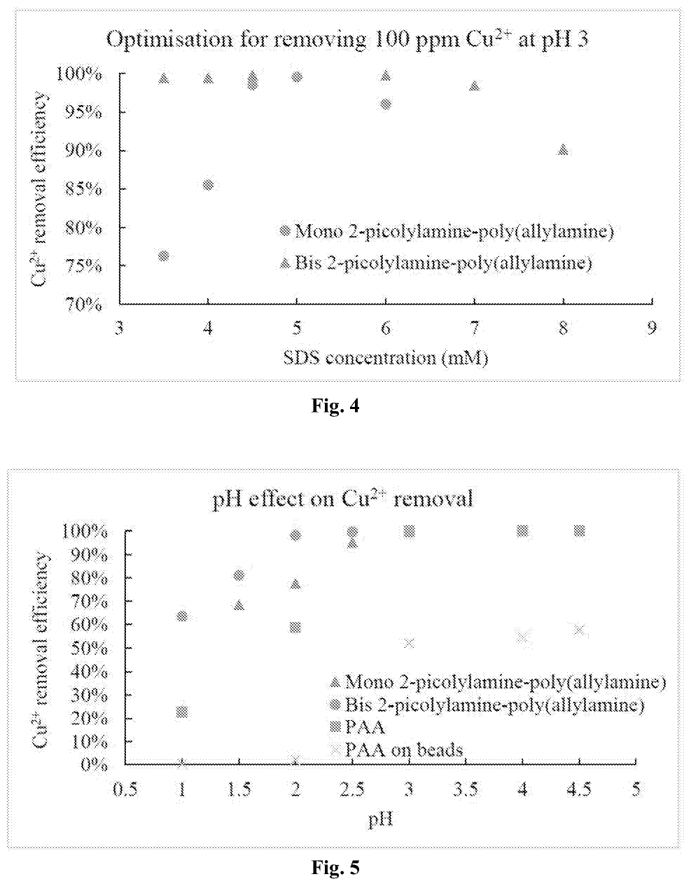

In FIG. 3, a mixed iron-copper effluent which is relatively dilute in copper is tested and presented using a modified PEI. The results show that the removal efficiency of Cu²⁺ does not change significantly over a range of 4-6.5 mM SDS. This suggests that the range of optimum surfactant dosage for modified PEI and SDS is robust and has some degree of flexibility, which is beneficial for industrial application and allows some room for error in the dosing. Importantly, Picolyl modified PEI removes Cu²⁺ at a lower pH than unmodified PEI. The higher the ratio of picolyl chloride to PEI, the higher the Cu²⁺ removal at pH 2. This indicates that at pH 2 the removal of Cu²⁺ is mainly due to the bi-dentate picolyl amine group, rather than the amine groups of the unmodified polymer. Even at a picolyl chloride to PEI molar ratio of only 0.2, the removal efficiency of Cu²⁺ is slightly higher than that for the unmodified PEI (FIG. 1) when tested at the same pH and without 500 ppm Fe³⁺. Most importantly, though, little Fe³⁺ is removed at all by the modified PEI at any molar ratio of modification. The 10-20% removal efficiency observed in FIG. 3 is actually an experimental artefact due to the dilution from polymer and surfactant stock solutions. In short, the selective removal of Cu²⁺ from Fe³⁺ at pH 2 is achieved by modifying the PEI with picolyl chloride at a molar ratio of 0.2-1, preferably 0.5-1, picolyl chloride to PEI.

### Example 2: Using the polymer Polyallylamine (PAA)

In FIG. 4, the dosage of SDS is optimised against two 800 ppm modified PAAs for removing 100 ppm Cu²⁺ at pH 3. In this case, the best dosage is determined by the removal efficiency of Cu²⁺, the settling speed of the precipitates and their compactness. The latter two characteristics are determined by observation. Thus, an advantageous dosage for removing 100 ppm Cu²⁺ using 800 ppm mono 2-picolylamine modified PAA is 5 mM SDS, and for bis 2-picolylamine modified PAA it is 4 mM SDS. The SDS dosage is similar for both polymers; in fact, its range depends mainly on the pH, the concentration of the multivalent ions and the polymer dose and, to a lesser extent, on the polymer functionalisation employed. In this case, the range for effective removal is more robust to SDS dosage for the bis 2-picolylamine modified PAA.

In FIG. 5, the effects of pH on Cu²⁺ removal are again studied in order to determine if PAA and its modified versions can be used for Cu/Fe separation. The results show that unmodified PAA, both in free solution form and fixed onto silica beads, can only effectively remove Cu²⁺ at a pH above 3, which is similar to that observed for PEI; furthermore, the performance of the ion exchange process is much poorer. On the other hand, mono and bis 2-picolylamine modified PAA can effectively remove Cu²⁺ at lower pH's, for instance at pH's of 3 or lower. Mono 2-picolylamine modified PAA can for example very effectively remove Cu²⁺ at pH's above 1.5, especially at pH's above 2-2.5; bis 2-picolylamine modified PAA even works very effectively at pH's above 1.0, especially at pH's above 1.5-2. Thus, Cu²⁺ can be removed at a lower pH when the PAA is modified with picolyl chloride. The tri-dentate PAA (bis 2-picolylamine modified) works at a lower pH than the bi-dentate PAA (mono 2-picolylamine modified) PAA, since the former has a stronger ligand for binding Cu²⁺. The mono-dentate PAA is the weakest among the three types of PAA.

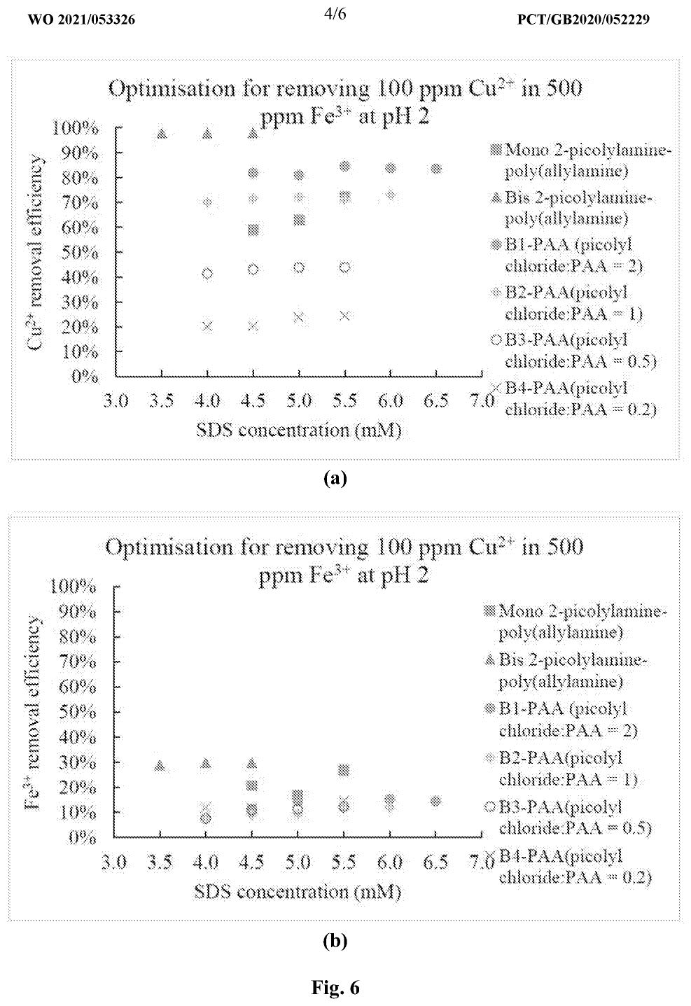

In FIG. 6, various modified PAAs are tested in the PSA process for selective Cu/Fe separation. The trend is the same as that observed in FIG. 3. FIG. 6(a) presents a selection of mono and bis 2-picolylamine modified PAAs and picolyl chloride modified PAAs at different molar ratios. At a molar ratio for picolyl chloride to PAA of 2, 85% of the Cu²⁺ is removed with little simultaneous removal of Fe³⁺. Thus, in some cases, if 85% of the Cu²⁺ removal is sufficient, then achieving 99% removal may be unnecessary using purified bis 2-picolylamine modified PAA. This could potentially simplify the procedure of PAA modification. In addition, the purified bis 2-picolylamine modified PAA exhibits the strongest removal for Cu²⁺, but the subsequent recovery can be relatively difficult using acidification. Thus, there is a trade-off here between the higher removal efficiency of Cu²⁺ at an acidic condition and the lower recovery of Cu²⁺ using acidification, since the modified polymer now binds the copper ion relatively more strongly than the proton ion. Using an amine displacement, however, is an alternative method to recover the Cu²⁺ from the precipitates.

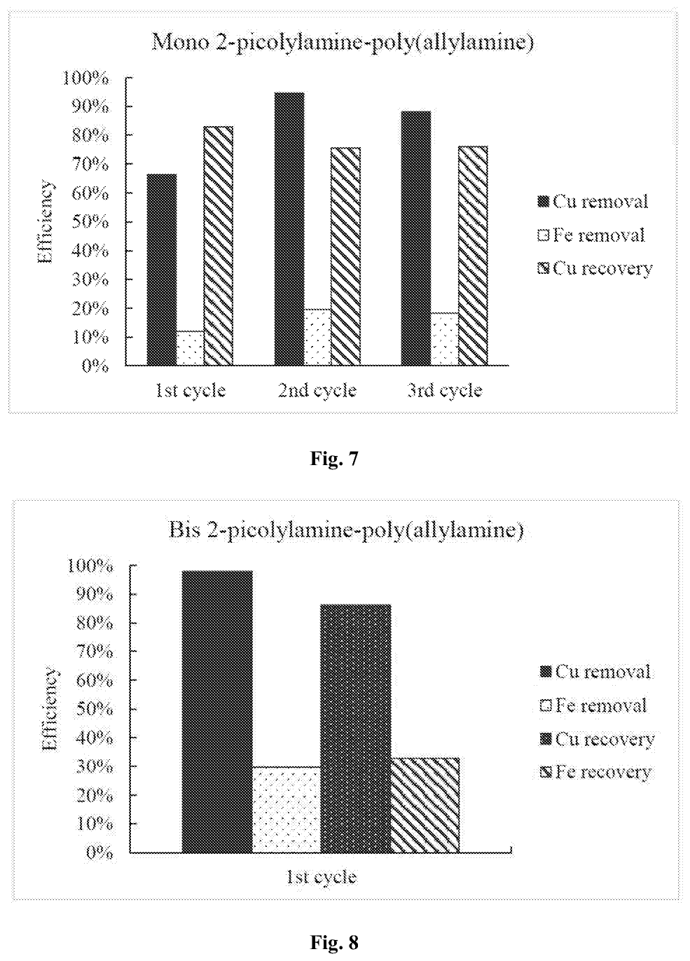

In FIG. 7, the viability of the recycle and reuse of the mono 2-picolylamine modified PAA and the SDS (i.e. the removal agents) is tested for the whole treatment process for three cycles. Of particular benefit is the fact that the removal efficiencies of Cu²⁺ in the 2nd and 3rd cycles are higher than for the first one (whilst those for Fe³⁺ are also slightly higher); a shorter flocculation time is also observed for the latter cycles. These suggest that the relative dosage of polymer and surfactant can self-correct after recovery from the precipitates. The removal efficiency remains at a high level, suggesting that the recovered polymer and surfactant can be reused as though they were new. It is worth noting that the required pH for recovery is 1 and 13 for Cu²⁺ and polymer/surfactant respectively. These values are relatively mild, which saves on acidification/basification chemical costs and reduces the health and safety risks. Based on experimental observations, the PSA precipitates can indeed be recovered at a lower pH e.g. 12-12.5, but a longer mixing time may be required. This represents a trade-off between pH and mixing time, which can be optimised for specific applications.

Regarding bis-2-picolylamine modified PAA in FIG. 8, the recovery of Cu²⁺ via acidification needs 2 M H₂SO₄ solution (pH −0.6) rather than 0.05 M (pH 1) for mono 2-picolylamine modified PAA. In 2 M H₂SO₄ solution, some of the SDS is protonated and dissolved in the acidic solution. This infers the disadvantage of some SDS wastage, and also contaminates the recovered Cu²⁺ with SDS. However, an alternative Cu²⁺ recovery method, in which an amine solution is used to displace Cu²⁺ from the polymer, solves this issue.

In terms of recovering a PSA comprising SDS and bis-2-picolylamine modified PAA, cationic bis-2-picolylamine modified PAA is hydrophobic and may be insoluble in a base solution, in which case polymer-surfactant recovery via basification would not be ideal. Instead of deprotonation/neutralisation of the cationic modified PAA, a more extreme acid (e.g. 10 M H₂SO₄ solution, pH −1.3) may successfully recover the polymer and surfactant via protonation/neutralisation of the SDS. The extreme nature of the acid required can be mitigated by using a weak acid surfactant, such as sodium myristate. Thus, in short, a two-step recovery process may be used for Cu²⁺ bound to a strong ligand:
(1) use amine solution to recover the Cu²⁺ ions;
(2) use ˜10 M H₂SO₄ solution to recover the polymer-surfactant precipitates.

### Cu Recovery is Unaffected by Salinity

FIG. 9 is a plot of experimental results showing the effect of ionic strength (represented as NaCl concentration) on copper removal efficiency using polymer-surfactant aggregates. Cu recovery was advantageously found to be unaffected by salinity. The initial Cu concentration was 16 mg/L (0.25 mM); pH=6; PEI concentration was 1.25 mM (˜54 mg/L), and SDS concentration 0.65 mM).

### Comments on Comparisons with Ion Exchange Processes

As both ion exchange processes and the new polymer-surfactant aggregate process use polymers for the charged species removal step, a brief comparison is valuable.

The polymer-surfactant aggregate (PSA) process and the ion exchange process show some similarities, and some differences. They can both separate Cu²⁺ from Fe³⁺ solutions. The differences between the two lie mainly in the mass transfer kinetics, the process design and the selection of the polymer. The mass transfer kinetics of the homogenous PSA process are significantly quicker than the heterogeneous ion exchange process. The ion exchange process can be operated continuously. Although the PSA process at the moment is a batch process, it has the potential to be operated as a continuous or semi-continuous system with multiple sedimentation tanks. Regarding the selection of polymer, a hydrophilic polymer is preferred in the PSA process for treating water-based solutions in order to disperse the polymer in the solution, although there is no such restriction in ion exchange process as the polymers are fixed onto the resin beads. In comparison, the homogenous PSA process will have a much higher rate of removal, a higher operating capacity and a lower complexity than the ion exchange process. Since the removal reagents can be recycled, the material costs are lower. Therefore, the rates of return on industrial effluent recovery projects employing the PSA process are expected to be significantly higher. In addition to the three main differences, there are some minor ones. PSA seems to offer one additional mechanism to remove colloidal metals via sweep flocculation. PSA benefits from a dosage optimisation for polymer and surfactant, and ion exchange needs the polymers to be fixed on the resin.

The key results, when PSA and ion-exchange are considered and compared as alternative process technologies, have shown that:
95% of 100 ppm Cu²⁺ was removed from 500 ppm Fe³⁺ (of which little was removed) at pH 2 using 800 ppm mono 2-picolylamine modified PAA and 5 mM SDS.
75% of Cu²⁺ was recovered using pH 1 solution; the polymer and surfactant were recovered using pH 13 solution and reused after several cycles with the same reagent potency as new.
The selective removal of Cu²⁺ from Fe³⁺ was achieved by modifying PEI with picolyl chloride at a molar ratio for picolyl chloride to PEI of 0.2-1, in particular 0.5-1.
Dosage of polymer and surfactant may be varied to achieve high removal efficiency of the metal ions; it depends mainly on the pH, the concentration of multivalent ions and the polymer dose.
The dosage of polymer and surfactant can self-correct during recycle after recovery from the floccualtes.

For ligand-modified polymers, the stronger the ligand is, the better the removal of

Cu²⁺ will be, but this can come at the price of a more difficult recovery using acidification.

In certain key operations, the PSA process therefore shows a clear superiority over the ion-exchange process.

Further embodiments of the invention are described in the following numbered clauses:

1. A process for selectively removing a first charged species from a plurality of charged species in solution, which process comprises:
treating a solution with a functionalised polymer and a surfactant, wherein the solution comprises a plurality of charged species dissolved in a solvent, wherein the plurality of charged species comprises the first charged species and at least one further charged species which is different from the first charged species, and wherein the functionalised polymer comprises groups that bind preferentially to the first charged species.

2. A process according to clause 1 wherein the groups that bind preferentially to the first species comprise chelating groups.

3. A process according to clause 1 or clause 2 wherein the groups that bind preferentially to the first species comprise bidentate or tridentate chelating groups.

4. A process according to any one of clauses 1 to 3 wherein the functionalised polymer is hydrophilic.

5. A process according to any one of the preceding clauses wherein the functionalised polymer comprises ionisable groups.

6. A process according to any one of the preceding clauses wherein the functionalised polymer is a positively charged polymer when in aqueous solution.

7. A process according to any one of the preceding clauses wherein the functionalised polymer comprises primary, secondary, tertiary or quaternary amine groups.

8. A process according to any one of the preceding clauses wherein the functionalised polymer is a polyamine which is functionalised to provide said groups that bind preferentially to the first charged species.

9. A process according to clause 8 wherein the polyamine is polyethylenimine (PEI) or polyallylamine (PAA).

10. A process according to clause 8 or clause 9 wherein the groups that bind preferentially to the first charged species comprise mono-2-picolyl amine groups or bis-2-picolyl amine groups.

11. A process according to any one of the preceding clauses wherein the functionalised polymer comprises polyethylenimine (PEI) functionalised with 2-picolyl groups, preferably wherein the functionalised polymer comprises N-(2-picolyl)-substituted PEI.

12. A process according to any one of the preceding clauses wherein the functionalised polymer comprises functionalised units of formula (X), functionalised units of formula (Y), and/or functionalised units of formula (Z)

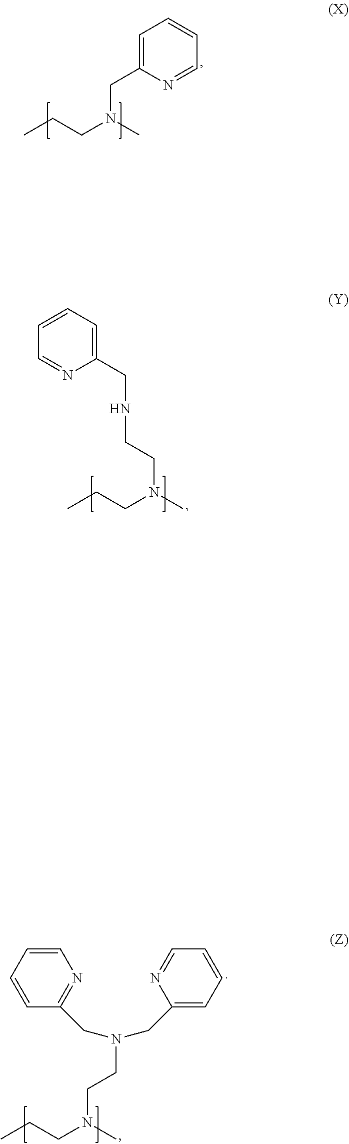

13. A process according to clause 12 wherein the functionalised polymer further comprises unfunctionalised units of formula (V) and/or unfunctionalised units of formula (W)

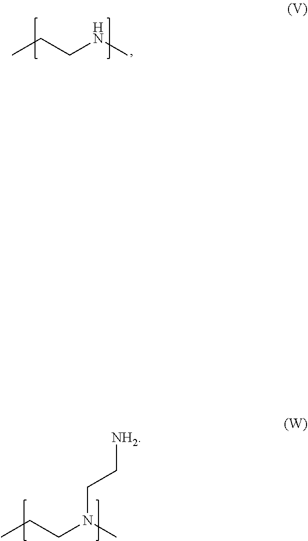

14. A process according to any one of clauses 11 to 13 wherein the ratio of 2-picolyl groups per nitrogen atom in the PEI is at least 0.2:1, optionally from 0.2:1 to 1:1.

15. A process according to any one of clauses 11 to 14 wherein the ratio of 2-picolyl groups per nitrogen atom in the PEI is at least 0.5:1, optionally from 0.5:1 to 1:1.

16. A process according to any one of the preceding clauses wherein the functionalised polymer is obtainable by treating polyethylenimine (PEI) with 2-picolyl chloride or a salt thereof, or with pyridine-2-carboxaldehyde.

17. A process according to any one of the preceding clauses wherein the functionalised polymer is obtainable by treating polyethylenimine (PEI) with 2-picolyl chloride or a salt thereof in a molar ratio of the 2-picolyl chloride or salt thereof to PEI monomer unit of at least 0.2:1, optionally from 0.2:1 to 1:1; or wherein the functionalised polymer is obtainable by treating polyethylenimine (PEI) with pyridine-2-carboxaldehyde in a molar ratio of the pyridine-2-carboxaldehyde to PEI monomer unit of at least 0.2:1, optionally from 0.2:1 to 1:1.

18. A process according to any one of the preceding clauses wherein the functionalised polymer is obtainable by treating polyethylenimine (PEI) with 2-picolyl chloride or a salt thereof in a molar ratio of the 2-picolyl chloride or salt thereof to PEI monomer unit of at least 0.5:1, optionally from 0.5:1 to 1:1; or wherein the functionalised polymer is obtainable by treating polyethylenimine (PEI) with pyridine-2-carboxaldehyde in a molar ratio of the pyridine-2-carboxaldehyde to PEI monomer unit of at least 0.5:1, optionally from 0.5:1 to 1:1.

19. A process according to any one of clauses 1 to 10 wherein the functionalised polymer comprises poly(allylamine) (PAA) functionalised with 2-picolyl groups, preferably wherein the functionalised polymer comprises N-(2-picolyl)-substituted PAA.

20. A process according to any one of clauses 1 to 10 and 19 wherein the functionalised polymer comprises functionalised units of formula (I) and/or functionalised units of formula (II)

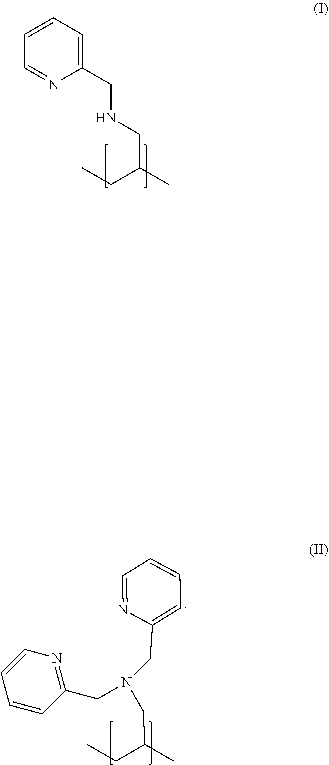

21. A process according to clause 20 wherein the functionalised polymer further comprises unfunctionalised units of formula (III)

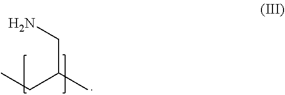

22. A process according to any one of clauses 19 to 21 wherein the functionalised polymer comprises mono 2-picolylamine modified PAA, which comprises units of formula

(I)

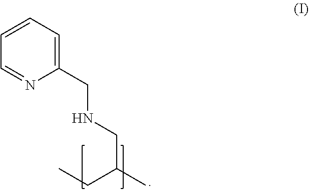

23. A process according to any one of clauses 19 to 21 wherein the functionalised polymer comprises bis 2-picolylamine modified PAA, which comprises units of formula (II)

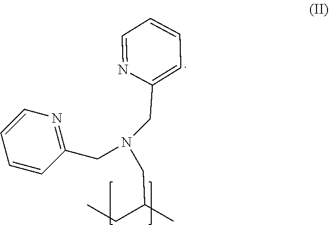

24. A process according to any one of clauses 19 to 21 wherein the ratio of 2-picolyl groups per nitrogen atom in the PAA is at least 0.2:1, optionally from 0.2:1 to 2:1; preferably wherein the ratio of 2-picolyl groups per nitrogen atom in the PAA is at least 0.5:1, optionally from 0.5:1 to 2:1.

25. A process according to any one of clauses 19 to 21 wherein the ratio of 2-picolyl groups per nitrogen atom in the PAA is at least 1:1, optionally from 1:1 to 2:1.

26. A process according to any one of clauses 1 to 10 and 19 to 21 wherein the functionalised polymer is obtainable by treating polyallylamine (PAA) with 2-picolyl chloride or a salt thereof, or with pyridine-2-carboxaldehyde.

27. A process according to any one of the preceding clauses wherein the functionalised polymer is obtainable by treating polyallylamine (PAA) with 2-picolyl chloride or a salt thereof in a molar ratio of the 2-picolyl chloride or salt thereof to PAA monomer unit of at least 0.2:1, optionally from 0.2:1 to 2:1; preferably in a molar ratio of the 2-picolyl chloride or salt thereof to PAA monomer unit of at least 0.5:1, optionally from 0.5:1 to 2:1;
or wherein the functionalised polymer is obtainable by treating polyallylamine (PAA) with pyridine-2-carboxaldehyde in a molar ratio of the pyridine-2-carboxaldehyde to PAA monomer unit of at least 0.2:1, optionally from 0.2:1 to 2:1; preferably in a molar ratio of the pyridine-2-carboxaldehyde to PAA monomer unit of at least 0.5:1, optionally from 0.5:1 to 2:1.

28. A process according to any one of the preceding clauses wherein the functionalised polymer is obtainable by treating polyallylamine (PAA) with 2-picolyl chloride or a salt thereof in a molar ratio of the 2-picolyl chloride or salt thereof to PAA monomer unit of at least 1:1, optionally from 1:1 to 2:1; or wherein the functionalised polymer is obtainable by treating polyallylamine (PAA) with pyridine-2-carboxaldehyde in a molar ratio of the pyridine-2-carboxaldehyde to PAA monomer unit of at least 1:1, optionally from 1:1 to 2:1.

29. A process according to any one of the preceding clauses wherein the surfactant is an ionic surfactant.

30. A process according to any one of the preceding clauses wherein the first charged species and the at least one further charged species are metallic ions.

31. A process according to any one of the preceding clauses wherein the first charged species and the at least one further charged species are positively charged species.

32. A process according to any one of the preceding clauses wherein the surfactant is an anionic surfactant, optionally wherein the surfactant is sodium dodecyl sulfate (SDS).

33. A process according to any one of the preceding clauses wherein the first charged species and the at least one further charged species are metal cations.

34. A process according to any one of the preceding clauses wherein:
the first charged species is a first noble metal cation and the at least one further charged species comprises one or more metal cations other than the first noble metal cation, optionally wherein the at least one further charged species comprises one or more further noble metal cations other than the first noble metal cation; or
the first charged species is a first platinum group metal cation and the at least one further charged species comprises one or more metal cations other than the first platinum group metal cation, optionally wherein the at least one further charged species comprises one or more further platinum group metal cations other than the first platinum group metal cation.

35. A process according to any one of the preceding clauses wherein the first charged species is a copper cation and the at least one further charged species comprises an iron cation, or wherein the first charged species is an iron cation and the at least one further charged species comprises a copper cation.

36. A process according to any one of the preceding clauses wherein the first charged species is Cu²⁺ and the at least one further charged species comprises Fe³⁺.

37. A process according to any one of the preceding clauses wherein the concentration of the first species in the solution is less than or equal to 100 ppm.

38. A process according to any one of the preceding clauses wherein the concentration of the at least one further charged species in the solution is at least twice the concentration of the first species in the solution, optionally at least five times the concentration of the first species in the solution.

39. A process according to any one of the preceding clauses wherein the concentration of the at least one further charged species in the solution is less than or equal to 1,000 ppm.

40. A process according to any one of the preceding clauses wherein the ratio of the monomeric molar concentration of the functionalised polymer to the molar concentration of the surfactant in the solution is from 1:4 to 4:1, preferably from 2:3 to 3:2.

41. A process according to any one of the preceding clauses wherein the monomeric molar concentration of the polymer in the solution is at least 1 mM, optionally from 1 mM to 10 mM, preferably from 3 mM to 7 mM, optionally about 5 mM.

42. A process according to any one of the preceding clauses wherein the concentration of the functionalised polymer in the solution in ppm is at least twice the concentration of the first charged species in the solution, optionally at least five times the concentration of the first charged species in the solution.

43. A process according to any one of the preceding clauses wherein the concentration of the functionalised polymer in the solution is at least 200 ppm, optionally at least 500 ppm, for instance from 200 ppm to 2,000 ppm, or from 500 ppm to 1,000 ppm.

44. A process according to any one of the preceding clauses wherein the molar concentration of the surfactant in the solution is at least 1 mM, optionally from 2 mM to 9 mM, preferably from 3 mM to 6 mM, for instance from 4 mM to 5 mM.

45. A process according to any one of the preceding clauses wherein the solvent comprises water and the solution is an aqueous solution.

46. A process according to any one of the preceding clauses wherein the solution treated with the functionalised polymer and the surfactant has a pH of less than or equal to 3, and optionally has a pH of from 0.5 to 2.5.

47. A process according to any one of clauses 1 to 5 wherein the functionalised polymer is a negatively charged polymer when in aqueous solution.

48. A process according to any one of clauses 1 to 5 and 47 wherein: (i) the first charged species and the at least one further charged species are negatively charged species, optionally metal-containing anions; and, preferably, (ii) the surfactant is a cationic surfactant.

49. A process according to any one of the preceding clauses wherein treating the solution with the functionalised polymer and the surfactant results in the first charged species binding to groups of the functionalised polymer that bind preferentially to the first charged species.

50. A process according to any one of the preceding clauses wherein treating the solution with the functionalised polymer and the surfactant results in the formation of a polymer-surfactant aggregate (PSA) which comprises the functionalised polymer and the surfactant.

51. A process according to clause 50 wherein the first charged species binds to groups of the functionalised polymer in the PSA that bind preferentially to the first charged species, to form a modified polymer-surfactant aggregate (modified PSA),
wherein the modified PSA comprises: (i) the PSA which comprises the functionalised polymer and the surfactant, and (ii) the first charged species which is bound to groups of the functionalised polymer in the PSA that bind preferentially to the first charged species.

52. A process according to any one of the preceding clauses wherein treating the solution with the functionalised polymer and the surfactant results in the formation of a modified polymer-surfactant aggregate (modified PSA) which comprises: (i) a polymer-surfactant aggregate (PSA) which comprises the functionalised polymer and the surfactant, and (ii) the first charged species, which is bound to groups of the functionalised polymer in the PSA that bind preferentially to the first charged species.

53. A process according to any one of the preceding clauses which further comprises separating from the solution a composition comprising the functionalised polymer, the surfactant and the first charged species, wherein the first charged species is bound to said groups of the functionalised polymer that bind preferentially to the first charged species.

54. A process according to clause 53 wherein the composition comprises a modified PSA as defined in clause 51 or clause 52, which comprises: (i) a polymer-surfactant aggregate (PSA) which comprises the functionalised polymer and the surfactant, and (ii) the first charged species, which is bound to groups of the functionalised polymer in the PSA that bind preferentially to the first charged.

55. A process according to clause 54 wherein separating the composition from the solution comprises self-flocculation of the modified PSA.

56. A process according to any one of clauses 53 to 55 wherein separating the composition from the solution comprises separation by:
a separation method based on real or artificial gravity, centrifugation, adsorption, decantation, elutriation, filtration, magnetic separation, sedimentation or sieving, or a combination thereof.

57. A process according to any one of clauses 53 to 56 wherein separating the composition from the solution comprises sedimentation and/or passing the solution through a filter.

58. A process according to any one of clauses 53 to 57 wherein the process further comprises removing the first charged species from the composition comprising the functionalised polymer, the surfactant and the first charged species.

59. A process according to clause 58 wherein the composition comprises a modified PSA as defined in clause 51 or clause 52, and removing the first charged species from said composition comprises removing the first charged species from the modified PSA.

60. A process according to clause 58 or clause 59 wherein removing the first charged species from the composition comprises forming a dissolved salt of the first charged species.

61. A process according to clause 60 wherein forming a dissolved salt of the first charged species comprises adjusting the pH.

62. A process according to clause 61, wherein the first charged species and the at least one further charged species are positively charged species and adjusting the pH comprises treating the composition with an acidic solution.

63. A process according to clause 61 or clause 62 wherein adjusting the pH comprises reducing the pH, optionally to a pH of less than or equal to 1.5, or to a pH of less than or equal to 0.

64. A process according to any one of clauses 61 to 63 wherein adjusting the pH comprises treating the composition with an acid, optionally wherein the acid comprises an inorganic acid (for instance sulfuric acid), a sulfonic acid, a carboxylic acid or a halogenated carboxylic acid.

65. A process according to any one of clauses 58 to 60 wherein removing the first charged species from the composition comprises treating the composition with an amine solution.

66. A process according to clause 61, wherein the first charged species and the at least one further charged species are negatively charged species and adjusting the pH comprises treating the composition with an alkaline solution.

67. A process according to any one of clauses 60 to 66 wherein the process further comprises separating the dissolved salt of the first charged species from the functionalised polymer and the surfactant.

68. A process according to clause 67 wherein separating the dissolved salt from the functionalised polymer and the surfactant comprises filtration, optionally wherein separating the salt from the functionalised polymer and the surfactant comprises filtering a composition comprising (i) a solution of the salt, and (ii) a precipitate comprising the functionalised polymer and the surfactant.

69. A process according to clause 58 or clause 59 wherein removing the first charged species from the composition comprises heating the composition and recovery of the first charged species in the form of an oxide comprising the first charged species.

70. A process according to any one of clauses 58 to 69 wherein the process further comprises, after the step of removing the first charged species from the composition, recovering the functionalised polymer and/or the surfactant.

71. A process according to clause 70 wherein recovering the functionalised polymer and/or the surfactant comprises adjusting the pH of a composition comprising the functionalised polymer and the surfactant.

72. A process according to clause 70 or clause 71 wherein the first charged species and the at least one further charged species are positively charged species, and the step of recovering the functionalised polymer and/or the surfactant comprises treating the composition comprising the functionalised polymer and the surfactant with an alkaline solution.

73. A process according to clause 70 or clause 71 wherein the first charged species and the at least one further charged species are negatively charged species, and the step of recovering the functionalised polymer and/or the surfactant comprises treating the composition comprising the functionalised polymer and the surfactant with an acid.

74. A process according to any one of clauses 70 to 73 wherein the process further comprises re-using the recovered functionalised polymer and/or the recovered surfactant in a further cycle of the process for selectively removing a charged species from a solution, optionally wherein the further cycle of the process is a process as defined in any one of the preceding clauses.

75. Use of a functionalised polymer and a surfactant to selectively remove a first charged species from a solution comprising a plurality of charged species dissolved in a solvent, wherein the plurality of charged species comprises the first charged species and at least one further charge species which is different from the first charged species, and the functionalised polymer comprises groups that bind preferentially to the first species.

76. Use of a polymer-surfactant aggregate (PSA) to selectively remove a first charged species from a solution comprising a plurality of charged species dissolved in a solvent, wherein the polymer-surfactant aggregate comprises a functionalised polymer and a surfactant, the plurality of charged species comprises the first charged species and at least one further charge species which is different from the first charged species, and the functionalised polymer comprises groups that bind preferentially to the first species.

77. The use according to clause 75 or clause 76 wherein the functionalised polymer, the surfactant, the first charged species, the plurality of charged species, the at least one further charge species, the solution, the solvent, the polymer-surfactant aggregate, and/or the groups that bind preferentially to the first species, are as defined in any one of clauses 2 to 52.

78. A modified polymer-surfactant aggregate (modified PSA), which comprises:
(i) a polymer-surfactant aggregate (PSA), comprising a functionalised polymer and a surfactant; and
(ii) a first charged species,
wherein the functionalised polymer comprises groups that bind preferentially to the first charged species and the first charged species is bound to the groups.

79. A modified PSA according to clause 78 wherein the groups that bind preferentially to the first charged species comprise chelating groups.

80. A modified PSA according to clause 79 wherein the chelating groups comprise bidentate or tridentate chelating groups.

81. A modified PSA according to clause 79 or clause 80 wherein the chelating groups comprise mono-2-picolyl amine groups or bis-2-picolyl amine groups.

82. A modified PSA according to any one of clauses 78 to 81 wherein the functionalised polymer is as defined in any one of clauses 4 to 28.

83. A modified PSA according to any one of clauses 77 to 80 wherein the surfactant is an ionic surfactant, optionally wherein the surfactant is an anionic surfactant, optionally wherein the anionic surfactant is sodium dodecyl sulfate (SDS).

84. A modified PSA according to any one of clauses 78 to 83 wherein the first charged species is as defined in any one of clauses 30, 31 and 33 to 36.

85. A polymer-surfactant aggregate (PSA), comprising: (i) a functionalised polymer which comprises groups that are capable of binding preferentially to a first charged species, and (ii) a surfactant.

86. A polymer-surfactant aggregate according to clause 85, wherein the groups that are capable of binding preferentially to a first charged species comprise chelating groups.

87. A polymer-surfactant aggregate according to clause 86, wherein the chelating groups comprise bidentate or tridentate chelating groups.

88. A polymer-surfactant aggregate according to clause 86 or clause 87 wherein the chelating groups comprise mono-2-picolyl amine groups or bis-2-picolyl amine groups.

89. A polymer-surfactant aggregate according to any one of clauses 85 to 88 wherein the functionalised polymer is as defined in any one of clauses 4 to 28.

90. A polymer-surfactant aggregate according to any one of clauses 85 to 89 wherein the surfactant is an ionic surfactant, optionally wherein the surfactant is an anionic surfactant, optionally wherein the anionic surfactant is sodium dodecyl sulfate (SDS).

1. A process for selectively removing a first charged species from a plurality of charged species in solution, which process comprises:
treating a solution with a functionalised polymer and a surfactant, wherein the solution comprises a plurality of charged species dissolved in a solvent, wherein the plurality of charged species comprises the first charged species and at least one further charged species which is different from the first charged species, and wherein the functionalised polymer comprises groups that bind preferentially to the first charged species.

2. A process according to claim 1 wherein the groups that bind preferentially to the first species comprise chelating groups, preferably bidentate or tridentate chelating groups.

3. A process according to any one of the preceding claims wherein the functionalised polymer is a positively charged polymer when in aqueous solution.

4. A process according to any one of the preceding claims wherein the functionalised polymer is a polyamine which is functionalised to provide said groups that bind preferentially to the first charged species, optionally wherein: the polyamine is polyethylenimine (PEI) or polyallylamine (PAA), and the groups that bind preferentially to the first charged species comprise mono-2-picolyl amine groups or bis-2-picolyl amine groups.

5. A process according to any one of the preceding claims wherein:
(A) the functionalised polymer comprises functionalised units of formula (X), functionalised units of formula (Y), and/or functionalised units of formula (Z) 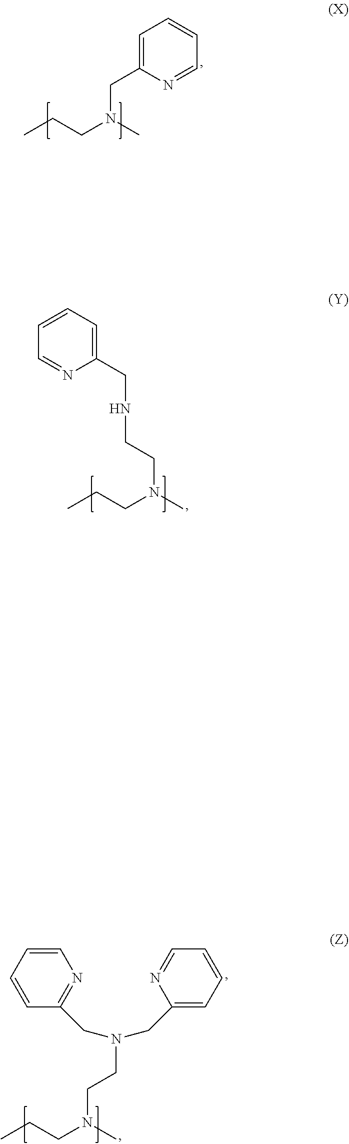
and optionally further comprises unfunctionalised units of formula (V) and/or unfunctionalised units of formula (W) 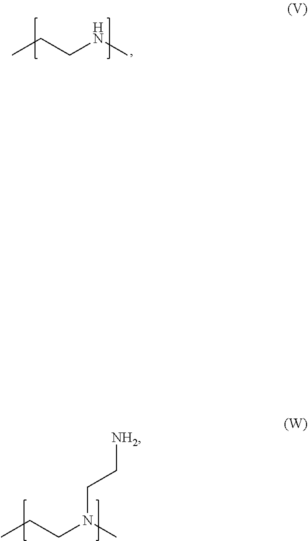
preferably wherein the functionalised polymer comprises N-(2-picolyl)-substituted PEI;
or
(B) the functionalised polymer comprises functionalised units of formula (I) and/or functionalised units of formula (II) 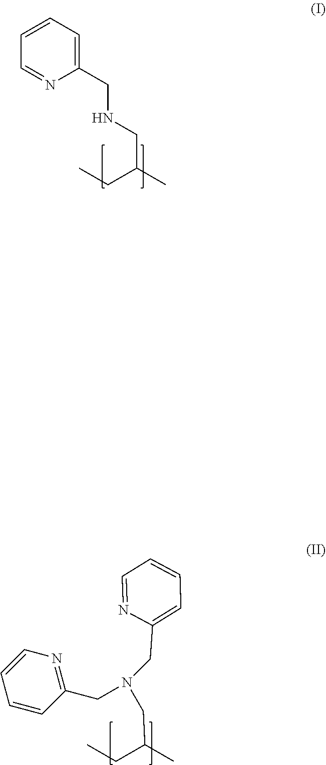
and optionally further comprises unfunctionalised units of formula (III) 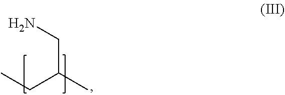
preferably wherein the functionalised polymer comprises N-(2-picolyl)-substituted PAA.

6. A process according to any one of the preceding claims wherein the first charged species and the at least one further charged species are positively charged species, optionally metal cations, and the surfactant is an anionic surfactant, optionally wherein the surfactant is sodium dodecyl sulfate (SDS).

7. A process according to any one of the preceding claims wherein:
the first charged species is a first noble metal cation and the at least one further charged species comprises one or more metal cations other than the first noble metal cation, optionally wherein the at least one further charged species comprises one or more further noble metal cations other than the first noble metal cation; or
the first charged species is a first platinum group metal cation and the at least one further charged species comprises one or more metal cations other than the first platinum group metal cation, optionally wherein the at least one further charged species comprises one or more further platinum group metal cations other than the first platinum group metal cation; or
the first charged species is a copper cation and the at least one further charged species comprises an iron cation, or wherein the first charged species is an iron cation and the at least one further charged species comprises a copper cation.

8. A process according to any one of the preceding claims wherein the first charged species is Cu²⁺ and the at least one further charged species comprises Fe³⁺, the solvent comprises water and the solution is an aqueous solution, and the solution treated with the functionalised polymer and the surfactant has a pH of less than or equal to 3, optionally a pH of from 0.5 to 2.5.

9. A process according to claims 1 or claim 2 wherein: (i) the first charged species and the at least one further charged species are negatively charged species, optionally metal-containing anions; and, preferably, (ii) the surfactant is a cationic surfactant, and (iii) the functionalised polymer is a negatively charged polymer when in aqueous solution.

10. A process according to any one of the preceding claims wherein treating the solution with the functionalised polymer and the surfactant results in the first charged species binding to groups of the functionalised polymer that bind preferentially to the first charged species.

11. A process according to any one of the preceding claims wherein treating the solution with the functionalised polymer and the surfactant results in the formation of a modified polymer-surfactant aggregate (modified PSA) which comprises: (i) a polymer-surfactant aggregate (PSA) which comprises the functionalised polymer and the surfactant, and (ii) the first charged species, which is bound to groups of the functionalised polymer in the PSA that bind preferentially to the first charged species.

12. A process according to any one of the preceding claims which further comprises separating from the solution a composition comprising the functionalised polymer, the surfactant and the first charged species, wherein the first charged species is bound to said groups of the functionalised polymer that bind preferentially to the first charged species.

13. A process according to claim 12 wherein the composition comprises a modified PSA as defined in claim 11, which comprises: (i) a polymer-surfactant aggregate (PSA) which comprises the functionalised polymer and the surfactant, and (ii) the first charged species, which is bound to groups of the functionalised polymer in the PSA that bind preferentially to the first charged species, and wherein separating the composition from the solution comprises self-flocculation of the modified PSA.

14. A process according to claim 12 or claim 13 wherein the process further comprises removing the first charged species from the composition comprising the functionalised polymer, the surfactant and the first charged species.

15. A process according to claim 14 wherein the composition comprises a modified PSA as defined in claim 11, and removing the first charged species from said composition comprises removing the first charged species from the modified PSA.

16. A process according to claim 14 or claim 15 wherein removing the first charged species from the composition comprises forming a dissolved salt of the first charged species, optionally wherein forming a dissolved salt of the first charged species comprises adjusting the pH, optionally wherein:
the first charged species and the at least one further charged species are positively charged species and adjusting the pH comprises treating the composition with an acidic solution, optionally wherein adjusting the pH comprises reducing the pH to a pH of less than or equal to 1.5; or
the first charged species and the at least one further charged species are negatively charged species and adjusting the pH comprises treating the composition with an alkaline solution.

17. A process according to claim 16 wherein the process further comprises separating the dissolved salt of the first charged species from the functionalised polymer and the surfactant, optionally wherein separating the dissolved salt from the functionalised polymer and the surfactant comprises filtering a composition comprising (i) a solution of the salt, and (ii) a precipitate comprising the functionalised polymer and the surfactant.

18. A process according to any one of claims 14 to 17 wherein the process further comprises, after the step of removing the first charged species from the composition, recovering the functionalised polymer and/or the surfactant, optionally wherein recovering the functionalised polymer and/or the surfactant comprises adjusting the pH of a composition comprising the functionalised polymer and the surfactant.

19. A process according to claim 18 wherein the process further comprises re-using the recovered functionalised polymer and/or the recovered surfactant in a further cycle of the process for selectively removing a charged species from a solution, optionally wherein the further cycle of the process is a process as defined in any one of the preceding claims.

20. Use of a functionalised polymer and a surfactant to selectively remove a first charged species from a solution comprising a plurality of charged species dissolved in a solvent, wherein the plurality of charged species comprises the first charged species and at least one further charged species which is different from the first charged species, and the functionalised polymer comprises groups that bind preferentially to the first species.

21. Use of a polymer-surfactant aggregate (PSA) to selectively remove a first charged species from a solution comprising a plurality of charged species dissolved in a solvent, wherein the polymer-surfactant aggregate comprises a functionalised polymer and a surfactant, the plurality of charged species comprises the first charged species and at least one further charged species which is different from the first charged species, and the functionalised polymer comprises groups that bind preferentially to the first species.

22. A modified polymer-surfactant aggregate (modified PSA), which comprises:
(i) a polymer-surfactant aggregate (PSA), comprising a functionalised polymer and a surfactant; and
(ii) a first charged species,
wherein the functionalised polymer comprises groups that bind preferentially to the first charged species and the first charged species is bound to the groups.

23. A modified PSA according to claim 22 wherein the surfactant is an ionic surfactant and the groups that bind preferentially to the first charged species comprise chelating groups, optionally bidentate or tridentate chelating groups.

24. A polymer-surfactant aggregate (PSA), comprising: (i) a functionalised polymer which comprises groups that are capable of binding preferentially to a first charged species, and (ii) a surfactant.

25. A polymer-surfactant aggregate according to claim 24, wherein the surfactant is an ionic surfactant and the groups that are capable of binding preferentially to a first charged species comprise chelating groups, optionally bidentate or tridentate chelating groups.
